(19) United States
(12) Patent Application Publication
(10) Pub. No.: US 2008/0145522 A1
(43) Pub. Date: Jun. 19, 2008

(54) NANOHOLES AND PRODUCTION THEREOF, STAMPER AND PRODUCTION THEREOF, MAGNETIC RECORDING MEDIA AND PRODUCTION THEREOF, AND, MAGNETIC RECORDING APPARATUS AND METHOD

(75) Inventors: Ken-ichi Itoh, Kawasaki (JP); Hiroshi Nakao, Kawasaki (JP); Hideyuki Kikuchi, Kawasaki (JP); Mineo Moribe, Kawasaki (JP); Hideki Masuda, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJISTU LIMITED, Kawasaki-shi (JP); KANAGAWA ACADEMY OF SCIENCE AND TECHNOLOGY, Kawasaki-shi (JP)

(21) Appl. No.: 11/943,850

(22) Filed: Nov. 21, 2007

Related U.S. Application Data
(62) Division of application No. 11/087,744, filed on Mar. 24, 2005.

(30) Foreign Application Priority Data
Mar. 26, 2004 (JP) 2004-092155
Mar. 4, 2005 (JP) 2005-061664

(51) Int. Cl. B05D 5/00

(52) U.S. Cl. 427/129

(57) ABSTRACT

A nanohole structure includes a metallic matrix and nanoholes arrayed regularly in the metallic matrix, in which the nanoholes are spaced in rows at specific intervals to constitute rows of nanoholes. The rows of nanoholes are preferably arranged concentrically or helically. The nanoholes in adjacent rows of nanoholes are preferably arranged in a radial direction. The width of each row of nanoholes preferably varies at specific intervals in its longitudinal direction. A magnetic recording medium includes a substrate, and a porous layer on or above the substrate. The porous layer contains nanoholes each extending in a direction substantially perpendicular to a substrate plane, containing at least one magnetic material therein, and is the above-mentioned nanohole structure.

### CROSS-REFERENCE TO RELATED APPLICATIONS

This application is a division of U.S. application Ser. No. 11/087,744, filed on Mar. 24, 2005, which is based upon and claims the benefits of the priority from the prior Japanese Patent Application Nos. 2004-092155, filed on Mar. 26, 2004, and 2005-061664, filed on Mar. 4, 2005, the entire contents of which are incorporated herein by reference.

### BACKGROUND OF THE INVENTION

1. Field of the Invention

The present invention relates to nanohole structures useful in magnetic recording media, and methods for efficiently manufacturing the nanohole structure at low cost; relates to a stamper which can be suitably used for manufacturing the nanohole structure and enables efficient manufacture of the nanohole structure, and methods for manufacturing the stamper; relates to magnetic recording media which are useful in hard disk devices widely used as external storage for computers, and consumer-oriented video recorders, have a large capacity and enable high-speed recording, and methods for efficiently manufacturing the magnetic recording media at low cost; and relates to apparatus and methods for perpendicular magnetic recording using the magnetic recording media.

2. Description of the Related Art

With technological innovations in information technology industries, demands have been made to provide magnetic recording media which have a large capacity, enable high-speed recording and are available at low cost and thus to increase the recording density in such magnetic recording media. It has been attempted to increase the recording density in a magnetic recording medium by horizontally recording information on a continuous magnetic film in the medium. However, this technology almost reaches its limit. If crystal grains of magnetic particles constituting the continuous magnetic film have a large size, a complex magnetic domain structure is formed to thereby increase noise. In contrast, if the magnetic particles have a small size to avoid increased noise, the magnetization decreases with time due to thermal fluctuations, thus inviting errors. In addition, a demagnetizing field for recording relatively increases with an increasing recording density of the magnetic recording medium. Thus, the magnetic recording medium must have an increased coercive force and do not have sufficient overwrite properties due to insufficient writing ability of a recording head.

Intensive investigations on novel recording systems as an alternative for the horizontal recording system have been made recently. One of them is a recording system using a patterned magnetic recording medium, in which a magnetic film in the medium is not a continuous film but is in the pattern of, for example, dot, bar or pillar on the order of nanometers and thereby constitutes not a complex magnetic domain structure but a single domain structure (e.g., S. Y. Chou Proc. IEEE 85 (4), 652 (1997)). Another is a perpendicular recording system, in which a recording demagnetization field is smaller and information can be recorded at a higher density than in the horizontal recording system, the recording layer can have a somewhat large thickness and the recording magnetization is resistant to thermal fluctuations (e.g., Japanese Patent Application Laid-Open (JP-A) No. 06-180834). On the perpendicular recording system, JP-A No. 52-134706 proposes a combination use of a soft magnetic film and a perpendicularly magnetized film. However, this technique is insufficient in writing ability with a single pole head. To avoid this problem, JP-A No. 2001-283419 proposes a magnetic recording medium further comprising a soft magnetic underlayer. Such magnetic recording on a magnetic recording medium according to the perpendicular recording system is illustrated in FIG. 1. A read-write head (single pole head) 100 of perpendicular-magnetic-recording system has a main pole 102 facing a recording layer 30 of the magnetic recording medium. The magnetic recording medium comprises a substrate, a soft magnetic layer 10, an interlayer (nonmagnetic layer) 20 and a recording layer (perpendicularly magnetized film) 30 arranged in this order. The main pole 102 of the read-write head (single pole head) 100 supplies a recording magnetic field toward the recording layer (perpendicularly magnetized film) 30 at a high magnetic flux density. The recording magnetic field flows from the recording layer (perpendicularly magnetized film) 30 via the soft magnetic layer 10 to a latter half portion 104 of the read-write head 100 to form a magnetic circuit. The latter half portion 104 has a portion facing the recording layer (perpendicularly magnetized film) 30 with a large size, and thereby its magnetization does not affect the recording layer (perpendicularly magnetized film) 30. The soft magnetic layer 10 in the magnetic recording medium also has the same function as the read-write head (single pole head) 100.

However, the soft magnetic layer 10 focuses not only the recording magnetic field supplied from the read-write head (single pole head) 100 but also a floating magnetic field leaked from surroundings to the recording layer (perpendicularly magnetized film) 30 to thereby magnetize the same, thus inviting increased noise in recording. The patterned magnetic film requires complicated patterning procedures and thus is expensive. In the magnetic recording medium having the soft magnetic underlayer, the soft magnetic underlayer must be arranged at a close distance from the single pole head in magnetic recording. Otherwise, a magnetic flux extending from the read-write head (single pole head) 100 to the soft magnetic underlayer 40 diverge with an increasing distance between the two components, and information is recorded in a broadened magnetic field with larger bits in the lower part of the recording layer (perpendicularly magnetized film) 30 arranged on the soft magnetic layer 10 (FIG. 2A). In this case, the read-write head (single pole head) 100 must supply an increasing write current. In addition, if a small bit is recorded after recording a large bit, a large portion of the large bit remains unerased, thus deteriorating the overwrite properties.

Certain magnetic recording medium according to the perpendicular recording system and the recording system using the patterned medium are proposed, for example, in JP-A No. 2002-175621. This type of magnetic recording media comprises a magnetic metal charged into pores of anodized alumina, on which information is recorded according to the perpendicular recording system using the patterned magnetic recording medium. More specifically, the magnetic recording medium comprises a substrate 110, an underlying electrode layer 120 and a layer of anodized alumina pore 130 (alumina layer) arranged in this order (FIG. 3). The anodized alumina pore layer 130 (alumina layer) includes a plurality of alumina pores arrayed regularly, and the alumina pores are filled with a ferromagnetic metal to form a ferromagnetic layer 140.

However, the anodized alumina pore layer 130 (alumina layer) must have a thickness exceeding 500 nm so as to form regularly arrayed alumina pores therein, and information cannot be recorded therein at a high density even if the soft magnetic underlayer is provided. To solve this problem, an attempt has been made to polish the anodized alumina pore layer 130 (alumina layer) to reduce its thickness. However, the polishing is difficult and takes a long time to perform, thus inviting higher cost and deteriorated quality of the product. In fact, to magnetically record information at a linear recording density of 1500 kBPI to realize a recording density of 1 Tb/in², the distance between the single pole head and the soft magnetic underlayer must be reduced to about 25 nm, and the thickness of the anodized alumina pore layer 130 (alumina layer) must be reduced to about 20 nm. It takes much time and effort to polish the anodized alumina pore layer 130 (alumina layer) to such a thickness.

In the magnetic recording medium comprising the anodized alumina pores filled with a magnetic material, the anodized alumina pores extend with a high aspect ratio in a direction perpendicular to an exposed surface. The medium is susceptible to magnetization in the perpendicular direction, is dimensionally anisotropic with respect to the magnetic material and is resistant to thermal fluctuations. The anodized alumina pores generally grow in a self-organizing manner to form honeycomb lattices of hexagonal closest packing and can be produced at lower cost than in the formation of such pores one by one by a lithographic technique.

However, the anodized alumina pores are spread two-dimensionally typically as lattices of hexagonal closest packing, and adjacent rows of bits are arranged closely without intervals or spacing. This is a critical defect in magnetic recording. Specifically, it is ideal to record one bit in one dot in the patterned medium. However, the dots are arranged at the same intervals not only in a linear direction (circumferential direction) but also in a radial direction, thus inviting crosswrite or crosstalk in adjacent tracks. With reference to FIGS. 4A and 4B, several to several tens or more of dots 61 should therefore constitute one bit 63 in FIG. 4B, but even in this case, the crosswrite or crosstalk still occurs (61: dot, 62: alumina, 63: one bit region, 64: underlying electrode layer, 65: backing layer, 66: substrate). A demand has therefore been made to provide a magnetic recording medium comprising anodized alumina pores which are filled with a magnetic material and are spaced in rows by a nonmagnetic region.

Certain patterned media comprise a substrate, and convex and concave portions on the substrate, in which a pattern is formed along the concave portions (grooves) (JP-A No. 2003-109333 and JP-A No. 2003-157503). In these media, a block copolymer or fine particles are spread two-dimensionally in a self-organization manner, and a magnetic material is charged or embedded in the grooves utilizing the two-dimensional pattern. However, this technique does not still realize pores arrayed in a line in one track. The publications also refer to a technique of forming a band structure made of aluminum in the concave portions and anodizing the band structure to thereby form a micro-nanohole array in a self-organization manner. However, this technique still fails to provide anodized alumina pores arrayed in a line in one track.

Patterned media in which a pattern of magnetic material is formed in a line by electron beam lithography or near-field optical lithography have been proposed in, for example, JP-A No. 2002-298448. It is possible in theory to array dots in a line in one track using a pattern aligner according to this technique. However, the technique requires post-processes such as etching and ion milling for the formation of magnetic dots after the formation of pattern. In addition, the magnetic material to be used is limited because it must exhibit anisotropy in a perpendicular direction for the perpendicular recording, thus inviting extra processes such as heat treatment, and increased cost. It takes a long time to form a dot pattern overall the media when the pattern has a small size on the order of nanometers, thus the throughput is decreased to invite increased cost. In such patterning over a long period of time, the intensity and focus of the electron beam or near-field light cannot be substantially maintained stably. The instability causes some defects to thereby decrease the yield and to increase the cost.

Accordingly, an object of the present invention is to solve the above problems in conventional technologies and to provide a nanohole structure which is useful in magnetic recording media, DNA chips, catalyst carriers and other applications, and a method for efficiently manufacturing the nanohole structure at low cost. Another object of the present invention is to provide a stamper which can be suitably used for manufacturing the nanohole structure and enables efficient manufacture of the nanohole structure, and a method for manufacturing the stamper. Yet another object of the present invention is to provide a magnetic recording medium which is useful in, for example, hard disk devices widely used as external storage for computers and consumer-oriented video recorders, enables recording of information at high density and high speed with a high storage capacity without increasing a write current of a magnetic head, exhibits satisfactory and uniform properties such as overwrite properties, avoids crosstalk and crosswrite and is of very high quality. Yet another object of the present invention is to provide a method for efficiently manufacturing the magnetic recording medium at low cost. A further object of the present invention is to provide an apparatus and method for perpendicular magnetic recording using the magnetic recording medium, which enable high-density recording.

### SUMMARY OF THE INVENTION

Specifically, the present invention provides, in a first aspect, a nanohole structure including a metallic matrix, and nanoholes being arrayed regularly in the metallic matrix, wherein the nanoholes are spaced in rows at specific intervals to constitute rows of nanoholes. The nanohole structure can be used, for example, as a magnetic recording medium for use in a hard disk device by charging at least one magnetic material into the nanoholes, as a DNA chip by charging DNA into the nanoholes, as a protein detecting device or diagnostic device by charging an antibody into the nanoholes, and as a substrate for the formation of a carbon nanotube or a field emission device by charging a catalytic metal typically for the formation of carbon nanotube into the nanoholes.

The present invention also provides, in a second aspect, a method for manufacturing the nanohole structure according to the first aspect of the present invention, comprising: forming a porous layer on a metallic matrix so as to have a thickness of 40 nm or more; removing the porous layer to thereby form a trace of the porous layer; and forming the porous layer on the trace of the porous layer, wherein the porous layer comprises nanoholes, the nanoholes each extending in a direction substantially perpendicular to the metallic matrix, and wherein the trace of the porous layer comprises concave portions being arrayed regularly, and wherein the concave portions are spaced in rows at specific interval to form rows of concave portions.

In the method for manufacturing the nanohole structure, when the porous layer comprising nanoholes, the nanoholes each extending in a direction substantially perpendicular to the metallic matrix is formed on the metallic matrix so as to have a thickness of 40 nm or more, and then the porous layer is removed, the nanoholes remains as the trace of the porous layer on the metallic matrix after the removal. Since the nanoholes exists as concave portions to the metallic matrix, the trace of the porous layer comprising concave portions arrayed regularly, the concave portions being spaced in rows at specific interval to constitute rows of concave portions, is obtained. Next, when the concave portions are used as an initiation site or points for forming nanoholes (which serves as an initiation site or points for forming nanoholes) and, once again, the porous layer is formed on the trace of the porous layer comprising the concave portions, the nanohole structure including nanoholes being arrayed regularly, wherein the nanoholes are spaced in rows at specific intervals to constitute rows of nanoholes, is manufactured easily and efficiently.

The present invention further provides, in a third aspect, a magnetic recording medium including a substrate, and a porous layer being arranged on the substrate with or without the interposition of one or more layers and comprising nanoholes, the nanoholes each extending in a direction substantially perpendicular to a substrate plane and containing at least one magnetic material therein, wherein the porous layer is the nanohole structure according to the first aspect of the present invention. In the magnetic recording medium, the rows of nanoholes are spaced at specific intervals, which rows of nanoholes each include nanoholes being filled with the magnetic material and being arrayed regularly. Thus, the magnetic recording medium enables recording of information at high density and high speed with a high storage capacity without increasing a write current of a magnetic head, exhibits satisfactory and uniform properties such as overwrite properties, avoids crosstalk and crosswrite and is of very high quality. The magnetic recording medium is useful in, for example, hard disk devices widely used as external storage for computers and consumer-oriented video recorders.

In the magnetic recording medium, it is preferred that the nanoholes each contain a soft magnetic layer and a ferromagnetic layer in this order from the substrate, and the ferromagnetic layer has a thickness equal to or less than that of the soft magnetic layer. In the magnetic recording medium, the ferromagnetic layer is arranged on or above the soft magnetic layer inside the nanoholes in the porous layer and has a thickness less than that of the porous layer. When magnetic recording is carried out on the magnetic recording medium using a single pole head, the distance between the single pole head and the soft magnetic layer is less than the thickness of the porous layer and is substantially equal to the thickness of the ferromagnetic layer. Thus, the convergence of a magnetic flux from the single pole head and the optimum properties for magnetic recording and reproduction at a recording density can be controlled only by controlling the thickness of the ferromagnetic layer, regardless of the thickness of the porous layer. As shown in FIGS. 2B and 5, the magnetic flux from the single pole head (read-write head) 100 converges to the ferromagnetic layer (perpendicularly magnetized film) 30. As a result, the magnetic recording medium exhibits significantly increased write efficiency, requires a decreased write current and has markedly improved overwrite properties as compared with conventional equivalents.

The present invention also provides, in a fourth aspect, a method for manufacturing the magnetic recording medium according to the third aspect of the present invention, comprising the processes of forming a nanohole structure, the process of forming a nanohole structure comprising forming a metallic layer on a substrate, and treating the metallic layer to thereby form nanoholes extending in a direction substantially perpendicular to a plane of the substrate to thereby form the nanohole structure as the porous layer; and charging at least one magnetic material into the nanoholes. The process of charging the magnetic material preferably comprises the processes of forming a soft magnetic layer in the nanoholes and forming a ferromagnetic layer on or above the soft magnetic layer.

According to the method for manufacturing the magnetic recording medium, a metallic layer is formed on a substrate and then is subjected to nanohole forming treatment to thereby form a plurality of nanoholes extending in a direction substantially perpendicular to the substrate plane in the process of forming the nanohole structure. In the process of charging the magnetic material, the magnetic material is charged into the nanoholes. Thus, the magnetic recording medium according to the third aspect of the present invention is efficiently manufactured at low cost. When the process of charging the magnetic material comprises the processes of forming a soft magnetic layer in the nanoholes and forming a ferromagnetic layer, a soft magnetic layer is formed in the nanoholes in the process of forming a soft magnetic layer. In the process of forming a ferromagnetic layer, a ferromagnetic layer is formed on or above the soft magnetic layer.

The present invention further provides, in a fifth aspect, a magnetic recording apparatus including the magnetic recording medium according to the third aspect of the present invention, and a perpendicular-magnetic-recording head. In the magnetic recording apparatus, information is recorded on the magnetic recording medium using the perpendicular-magnetic-recording head. The magnetic recording apparatus thus enables recording of information at high density and high speed with a high storage capacity without increasing a write current of the magnetic head, exhibits satisfactory and uniform properties such as overwrite properties, avoids crosstalk and crosswrite and is of very high quality.

In addition and advantageously, the present invention provides, in a fifth aspect, a magnetic recording method, including the process of recording information on the magnetic recording medium according to the third aspect of the present invention with the use of a perpendicular-magnetic-recording head. According to the magnetic recording method, information is recorded on the magnetic recording medium using the perpendicular-magnetic-recording head. Thus, the magnetic recording method enables recording of information at high density and high speed with a high storage capacity without increasing a write current of the magnetic head, exhibits satisfactory and uniform properties such as overwrite properties and avoids crosstalk and crosswrite. When the magnetic recording medium is one including the nanoholes each containing a soft magnetic layer and a ferromagnetic layer in this order from the substrate, and the ferromagnetic layer having a thickness equal to or less than that of the soft magnetic layer one, and magnetic recording is carried out on the magnetic recording medium using the perpendicular-magnetic-recording head such as a single pole head, the distance between the perpendicular-magnetic-recording head and the soft magnetic layer is less than the thickness of the porous layer and is substantially equal to the thickness of the ferromagnetic layer. Thus, the convergence of a magnetic flux from the perpendicular-magnetic-recording head and the optimum properties for magnetic recording and reproduction at a recording density in practice can be controlled only by controlling the thickness of the ferromagnetic layer, regardless of the thickness of the porous layer. As shown in FIGS. 2B and 5, the magnetic flux from the perpendicular-magnetic-recording head (read-write head) 100 converges to the ferromagnetic layer (perpendicularly magnetized film) 30. As a result, the magnetic recording method exhibits significantly increased write efficiency, requires a decreased write current and has markedly improved overwrite properties as compared with conventional equivalents.

Further objects, features and advantages of the present invention will become apparent from the following description of the preferred embodiments with reference to the attached drawings.

### BRIEF DESCRIPTION OF THE DRAWINGS

FIG. 1 is a diagram schematically illustrating magnetic recording according to the perpendicular magnetic recording system (perpendicular magnetic recording).

FIG. 2A is a schematic diagram showing the divergence of a magnetic flux in perpendicular magnetic recording.

FIG. 2B is a schematic diagram showing the convergence of a magnetic flux in perpendicular magnetic recording.

FIG. 3 is a schematic diagram illustrating a magnetic recording medium which is a patterned medium, comprises a magnetic metal in pores of anodized alumina and enables perpendicular recording.

FIGS. 4A and 4B are a schematic diagram and a sectional view thereof along the line B-B′, respectively, illustrating a magnetic recording medium comprising a magnetic metal charged in pores of anodized alumina spread two-dimensionally.

FIG. 5 is a schematic partial sectional view illustrating perpendicular-magnetic-recording on a magnetic recording medium using a single pole head.

FIG. 6A is a scanning electron micrograph illustrating a surface of an aluminum layer after imprint transfer from a mold.

FIG. 6B is a scanning electron micrograph illustrating the surface of the aluminum layer of FIG. 6A after anodization to form rows of nanoholes.

FIG. 7 is a scanning electron micrograph illustrating rows of nanoholes formed by scratching an aluminum layer and anodizing the scratched aluminum layer.

FIG. 8 is another scanning electron micrograph illustrating rows of nanoholes formed by scratching an aluminum layer and then anodizing the scratched aluminum layer.

FIGS. 9A to 9F are schematic diagrams illustrating a method for manufacturing the magnetic recording medium as an embodiment of the present invention.

FIG. 10 is a schematic diagram illustrating a magnetic recording medium as an embodiment of the present invention.

FIG. 11 is a schematic diagram illustrating rows of nanoholes in the magnetic recording medium.

FIGS. 12A and 12B are schematic diagrams illustrating the magnetic recording medium before and after, respectively, the formation of rows of nanoholes which are partitioned or spaced at specific intervals.

FIGS. 13A and 13B are schematic diagrams illustrating the magnetic recording medium before and after, respectively, the formation of rows of nanoholes each having a width varying at specific intervals.

FIG. 14 is a graph illustrating frequency analyses of readout waveforms by a spectrum analyzer.

FIG. 15 is a graph illustrating signal amplitudes as determined while off-tracking in reading.

FIG. 16 is a graph illustrating signal-to-noise ratios and overwrite properties of the magnetic recording medium according to the present invention and of a conventional magnetic recording medium.

FIG. 17A is a view (No. 1) illustrating a production process of the nanohole structure according to the present invention.

FIG. 17B is a view (No. 2) illustrating a production process of the nanohole structure according to the present invention.

FIG. 17C is a schematic diagram illustrating an example of the surface of an aluminum film after imprint transfer of a mold.

FIG. 17D is a view (No. 3) illustrating a production process of the nanohole structure according to the present invention.

FIG. 17E is a schematic diagram illustrating an example of the surface of an aluminum film after anodization.

FIG. 18A is a view (No. 4) illustrating a production process of the nanohole structure according to the present invention.

FIG. 18B is a schematic diagram illustrating an example of the surface of an aluminum film after removing a porous layer.

FIG. 18C is a view (No. 5) illustrating a production process of the nanohole structure according to the present invention.

FIG. 18D is a schematic diagram illustrating an example of array of nanoholes on the surface of the nanohole structure (arrayed nanohole structure) according to the present invention.

FIG. 19A is a schematic diagram illustrating an example of the trace transferring process by direct print.

FIG. 19B is a schematic diagram illustrating an example of the trace transferring process by heat imprint.

FIG. 19C is a schematic diagram illustrating an example of the trace transferring process by photo-imprint.

FIG. 19D is a schematic diagram explaining a step of peeling off a polymer layer in heat imprint and photo-imprint.

FIG. 19E is a schematic diagram explaining a residue treatment in heat imprint and photo-imprint.

FIG. 19F is a schematic diagram explaining an etching treatment in heat imprint and photo-imprint.

FIG. 20A is a cross-sectional picture illustrating an example of the vicinity of the surface of an aluminum film after anodization.

FIG. 20B is an enlarged picture of the X portion in the picture shown in FIG. 20A.

FIG. 21A is a picture illustrating an example of array of nanoholes on the surface of an aluminum film after anodization.

FIG. 21B is a picture illustrating an example of array of nanoholes at the depth of 200 nm from the surface of an aluminum film after anodization.

FIG. 22 is a picture illustrating an example of array of nanoholes on the surface of the nanohole structure (arrayed nanohole structure) of the present invention.

FIG. 23A is a schematic diagram illustrating an example of the nanohole structure forming process of the method for manufacturing the magnetic recording medium of the present invention.

FIG. 23B is a schematic diagram illustrating an example of array of nanoholes on the surface of the nanohole structure obtained by the nanohole structure forming process.

FIG. 23C is a schematic diagrams illustrating an example of the magnetic material charging process of the method for manufacturing the magnetic recording medium of the present invention.

FIG. 23D is a schematic diagrams illustrating an example of the polishing process of the method for manufacturing the magnetic recording medium of the present invention.

FIG. 23E is a schematic diagram illustrating an example of the surface of nanohole structure after polishing process.

FIG. 24A is a picture illustrating an example of the surface of nanohole structure before polishing process.

FIG. 24B is a picture illustrating an example of the surface of nanohole structure after polishing process.

FIG. 25A is a schematic diagram illustrating a configuration of the magnetic recording medium (magnetic disk test sample J) of the present invention.

FIG. 25B is a picture illustrating an example of the surface of arrayed nanohole structure of the magnetic recording medium of the present invention shown in FIG. 25A.

FIG. 26 is a graph illustrating a variation of the magnetic flux intensity of the magnetic recording medium (magnetic disk test samples J and A) of the present invention.

FIG. 27A is a view (No. 1) illustrating a production process of the stamper of the present invention.

FIG. 27B is a view (No. 2) illustrating a production process of the stamper of the present invention.

FIG. 27C is a view (No. 3) illustrating production process of the stamper of the present invention (a schematic diagram illustrating an example of the photopolymer stamper of the present invention).

FIG. 27D is a view (No. 4) illustrating a production process of the stamper of the present invention.

FIG. 27E is a view (No. 5) illustrating production process of the stamper of the present invention.

FIG. 27F is a view (No. 6) illustrating production process of the stamper of the present invention.

FIG. 27G is a schematic diagram illustrating an example of the Ni stamper of the present invention.

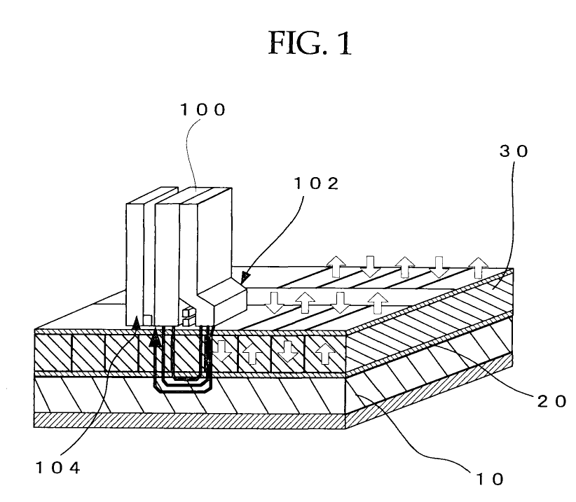

### DESCRIPTION OF THE PREFERRED EMBODIMENTS

### Nanohole Structure

The nanohole structure according to the present invention is not specifically limited, as long as it comprises a metallic matrix and nanoholes arrayed regularly in the metallic matrix, which nanoholes are spaced in rows at specific intervals to constitute rows of nanoholes, and its material, shape, configuration, size and other parameters are selected according to the purpose.

The material for the metallic matrix can be any suitable material selected according to the purpose, such as elementary metals, as well as oxides, nitrides and alloys of such metals. Among them, alumina (aluminum oxide), aluminum, glass and silicon are preferred.

The nanohole structure can have any suitable shape selected according to the purpose, of which a plate or disk shape is preferred. The nanohole structure typically preferably has a disk shape when it is used in magnetic recording media such as hard disks.

When the nanohole structure has a plate or disk shape, the nanoholes (fine pores) are arranged so as to extend in a direction substantially perpendicular to a free surface (plane) of the plate or disk.

The nanoholes may be through holes penetrating the nanohole structure or be pits or concave portions not penetrating the nanohole structure. The nanoholes are preferably through holes penetrating the nanohole structure when the nanohole structure is used, for example, in the magnetic recording medium.

The nanohole structure can have any suitable configuration according to the purpose and can be of, for example, a single layer structure or a multilayer structure.

The nanohole structure can have any suitable size set according to the purpose. For example, when it is used in a magnetic recording medium such as a hard disk, it preferably has a size corresponding to the size of regular hard disks. When it is used as a DNA chip, it preferably has a size corresponding to regular DNA chips. When it is used as a catalyst substrate such as a carbon nanotube for a field-emission device, it preferably has a size corresponding to the field-emission device.

The rows of nanoholes can be arranged in any suitable array according to the purpose. For example, they are preferably arranged in parallel so as to extend in one direction when the nanohole structure is used as a DNA chip. They are preferably concentrically or helically arranged when the nanohole structure is used in the magnetic recording medium such as a hard disk or video disk. More specifically, they are preferably concentrically arranged in the use for hard disks, and are preferably helically arranged in the use for video disks.

In the case that the nanohole structure is used in the magnetic recording medium such as a hard disk, the nanoholes in adjacent rows of nanoholes are preferably arranged in a radial direction. The resulting magnetic recording medium enables recording of information at high density and high speed with a high storage capacity without increasing a write current of the magnetic head, exhibits satisfactory and uniform properties such as overwrite properties, avoids crosstalk and crosswrite and is of very high quality.

The interval between adjacent rows of nanoholes can be any suitable interval. When the nanohole structure is used in the magnetic recording medium such as a hard disk, the interval is preferably from 5 nm to 500 nm and more preferably from 10 nm to 200 nm.

If the interval is less than 5 nm, the nanoholes may be difficult to form. If it exceeds 500 nm, the nanoholes may be difficult to array regularly.

The ratio of the interval between adjacent rows of nanoholes to the width of a row of nanoholes can be any suitable ratio and is preferably from 1.1 to 1.9 and more preferably from 1.2 to 1.8.

A ratio (interval/width) less than 0.1 may invite fused adjacent nanoholes and fail to provide separated nanoholes. A ratio exceeding 1.9 may invite formation of nanoholes in extra portions other than rows of concave portions in anodization.

The rows of nanoholes can each have any suitable width. When the nanohole structure is used in the magnetic recording medium such as a hard disk, the width is preferably from 5 to 450 nm and more preferably from 8 to 200 nm.

If the rows of nanoholes have a width less than 5 nm, the nanoholes may be difficult to form. If it exceeds 450 nm, the nanoholes may be difficult to array regularly.

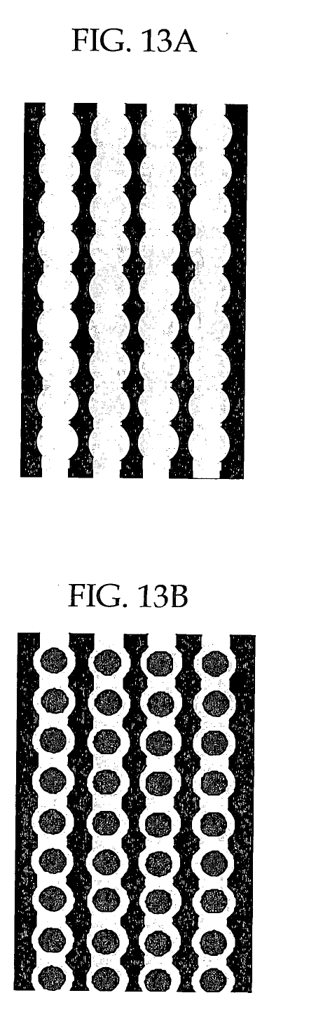

The width of each row of nanoholes may be constant or vary at specific intervals in a specific period in a longitudinal direction of the rows of nanoholes. In the latter case, the nanoholes can be easily formed in portions of the rows of nanoholes with a larger width (FIGS. 13A and 13B).

The nanoholes can have openings with any suitable diameter. When the nanohole structure is used in the magnetic recording medium such as a hard disk, the diameter of opening is preferably such that the ferromagnetic layer becomes a single domain structure and is preferably 200 nm or less and more preferably 5 to 100 nm.

If the nanoholes have openings with a diameter exceeding 200 nm, a magnetic recording medium having a single domain structure may not be obtained.

The nanoholes can have any suitable aspect ratio, i.e., a ratio of the depth to the diameter of opening. A high aspect ratio is preferable for higher anisotropy in dimensions and for higher coercive force of the magnetic recording medium. When the nanohole structure is used in the magnetic recording medium such as a hard disk, the aspect ratio is preferably 2 or more and more preferably 3 to 15.

An aspect ratio less than 2 may invite insufficient coercive force of the magnetic recording medium.

The coefficient of variation of the intervals between adjacent nanoholes can be any suitable one. Smaller coefficient of variation is preferred. When the nanohole structure is used in the magnetic recording medium such as a hard disk, the coefficient of variation is preferably 10% or less, more preferably 5% or less and particularly preferably 0%.

If the coefficient of variation exceeds 10%, the periodicity of magnetic signal pulse from each of the isolated magnetic material decrease, inviting deterioration of signal-to-noise ratios.

The coefficient of variation represents the extent to which measured value differs from the average value. The coefficient of variation can be, for example, obtained by measuring center-to-center distance of openings of adjacent nanoholes in a row of nanohole and calculating according to the following equation:

CV(%)=σ/<X>×100

wherein CV is the coefficient of variation; σ is standard deviation; and <X> is mean.

The nanohole structure can have any suitable thickness according to the purpose. When the nanohole structure is used in the magnetic recording medium such as a hard disk, the thickness is preferably 500 nm or less, more preferably 300 nm or less and typically preferably 20 to 200 nm.

If the nanohole structure having a thickness exceeding 500 nm is used in the magnetic recording medium such as a hard disk, information may not be recorded thereon at high density even if the magnetic recording medium further comprises the soft magnetic underlayer. Thus, the nanohole structure must be polished to reduce its thickness and the production of the magnetic recording medium may take a long time, invite higher cost and lead to deteriorated quality.

The nanohole structure can be prepared by any suitable method according to a conventional procedure. For example, it can be prepared by forming a layer of a metallic material by sputtering or vapor deposition and anodizing the metallic layer to form the nanoholes, but is preferably manufactured by the method for manufacturing a nanohole structure according to the present invention mentioned later.

It is preferable to form rows of concave portions for the formation of the rows of nanoholes on the metallic matrix before anodization. Thus, the nanoholes can be efficiently formed on the rows of concave portions alone as a result of anodization.

The rows of concave portions can have any suitable sectional profile in a direction perpendicular to the longitudinal direction, such as a rectangular, V-shaped or semicircular profile.

The rows of concave portions can be formed by any suitable method according to the purpose. Examples of such methods are (1) a method in which a mold (template) having a line-and-space pattern comprising lines of convex portions on its surface is imprinted and transferred to the metallic layer made of, for example, alumina or aluminum to thereby form a line-and-space pattern comprising rows of concave portions and spaces arranged at specific intervals alternately, wherein the convex portions are preferably arranged concentrically or helically when the nanohole structure is used in the magnetic recording medium; (2) a method in which a resin layer or photoresist layer is formed on the metallic layer, is then patterned by normal photo step and imprint method using a mold, and etched to thereby form the rows of concave portions on a surface of the metallic layer; and (3) a method in which grooves (rows of concave portions) are directly formed on the metallic layer.

The width of each row of nanoholes can vary at specific intervals (at regular intervals) in its longitudinal direction by varying, for example, the width of the lines of convex portions in the mold or the width of the pattern of rows of concave portions formed in the photoresist layer at specific intervals in its longitudinal direction. Thus, the magnetic recording medium using the nanohole structure enables high-density recording with reduced jitter.

The mold can be any suitable one according to the purpose but is preferably a silicon, silicon dioxide film and combination thereof from the viewpoint that they are most widely used as a material for manufacturing fine structure in the semiconductor field and is preferably a silicon carbide substrate as well as a Ni stamper used in molding of optical disks for high durability in continuous use. The mold can be used a plurality of times. The imprint transfer can be carried out according to any conventional procedure according to the purpose. The resist material for the photoresist layer includes not only photoresist materials but also electron beam resist materials. The photoresist material for use herein can be any suitable material known in the field of semiconductors, such as materials sensitive to near-ultraviolet rays or near-field light.

The anodization can be carried out at any suitable voltage but preferably at such a voltage satisfying the following equation: V=I/A, wherein V is the voltage in the anodization; I is the interval (nm) between adjacent rows of nanoholes; and A is a constant (nm/V) of 1.0 to 4.0.

When the anodization is carried out at a voltage satisfying the above equation, the nanoholes are advantageously arranged and spaced in rows in the rows of concave portions.

The anodization can be carried out under any suitable conditions including the type, concentration and temperature of an electrolyte and the time period for anodization set according to the number, size and aspect ratio of the target nanoholes. For example, the electrolyte is preferably a diluted phosphoric acid solution at intervals (pitches) of adjacent rows of nanoholes of 150 nm to 500 nm, is preferably a diluted oxalic acid solution at pitches of 80 nm to 200 nm, and is preferably a diluted sulfuric acid solution at a pitch of 10 nm to 150 nm. In any case, the aspect ratio of the nanoholes can be controlled by immersing the anodized metallic layer in, for example, a phosphoric acid solution to thereby increase the diameter of the nanoholes such as alumina pores.

The nanohole structure according to the present invention is useful in magnetic recording media such as hard disks widely used in external storage for computers and consumer-oriented video recorders, as well as DNA chips and catalyst substrates.

### Method for Manufacturing Nanohole Structure

The method for manufacturing a nanohole structure of the present invention is a method for manufacturing the nanohole structure of the present invention, includes a porous layer forming process and porous layer removing process in the order of a porous layer forming process (hereinafter may be referred to as “the first porous layer forming process”), porous layer removing process and porous layer forming process (hereinafter may be referred to as “the second porous layer forming process”), and may further include one or more of other processes if required.

### Porous Layer Forming Process

The porous layer forming process is a process for forming a porous layer on a metallic matrix in which a plurality of nanoholes extending in a direction substantially perpendicular to the metallic matrix are formed, and include a first porous layer forming process in which the porous layer is formed so as to have a thickness of 40 nm or more; and a second porous layer forming process in which a porous layer is formed on the obtained trace of the porous layer after the porous layer removing process mentioned later.

Details of the metallic matrix, nanohole, etc. have been described above.

In the first porous layer forming process, the porous layer are required to have a thickness of 40 nm or more, preferably 40 nm to 1 μm and in the second porous layer forming process, the thickness may be any suitable one according to the purpose and is, for example, preferably 500 nm or less and more preferably from 5 to 200 nm.

In the first porous layer forming process, if the porous layer has a thickness of 40 nm or more, a trace of the porous layer concave portions arrayed regularly, where the concave portions are formed in rows at specific interval to constitute rows of concave portions, can be obtained in the porous layer removing process mentioned later. In the porous layer, at the beginning of forming the porous layer, the nanoholes (alumina pores) are arranged in a disordered state, but as the formation of the porous layer processes, the nanoholes (alumina pores) are arranged in an ordered state. Therefore, surplus alumina pores are generated in the vicinity of the surface of the porous layer (less than 40 nm from the uppermost surface), causing irregular intervals of arranged alumina pores, but at the depth of 40 nm or more from the uppermost surface of the porous layer, surplus alumina pores are not generated and alumina pores are arrayed regularly and spaced in rows at specific intervals to constitute rows of alumina pores. Thus, the trace which is obtained by forming a porous layer so as to have a thickness of 40 nm or more, and then by removing the porous layer has regularly arrayed fine concave portion. By carrying out the second porous layer forming process using the trace as an initiation site or points for forming nanoholes (which serves as an initiation site or points for forming nanoholes), nanohole structure including nanoholes being arrayed regularly, where the nanoholes are formed in rows at specific intervals to constitute rows of nanoholes (hereinafter may be referred to as “arrayed nanohole structure”).

On the other hand, if the porous layer has a thickness of 1 μm or more, rearrangement to the hexagonal close-packed structure occurs and ideal array of nanoholes may not be obtained.

In the second porous layer forming process, if the thickness of the porous layer exceeds 500 nm, it causes certain problems. For example, when the nanohole structure is used in the magnetic recording medium such as a hard disk, it may prevent satisfactory charging of a magnetic material into the nanoholes.

The porous layer can be formed by any suitable method according to the purpose. It is preferable that the porous layer is formed by anodization after forming a layer of a metallic material by sputtering or vapor deposition.

It is preferable to form rows of concave portions for forming the rows of nanoholes on the metallic matrix before anodization. Thus, the nanoholes can be efficiently formed on the rows of concave portions alone as a result of anodization.

In addition, the rows of concave portions are preferably partitioned in the longitudinal direction at specific intervals. Thus, the magnetic recording medium using the nanohole structure enables high-density recording with reduced jitter.

The method of anodization, method of forming the rows of concave portions, etc. have been described in detail in the description of the above-mentioned nanohole structure.

### Porous Layer Removing Process

The porous layer removing process is a process where a porous layer formed by the first porous layer forming process is removed. By carrying out the porous layer removing process, a trace of the porous layer is obtained on the metallic matrix.

The trace of the porous layer comprises at least nanoholes remaining on the metallic matrix after the removal of the porous layer formed so as to have a thickness of 40 nm or more. Since the nanoholes are arrayed regularly and exists as concave portions to the metallic matrix, in the trace of the porous layer, fine concave portions are arrayed regularly and exists in rows at specific intervals to constitute rows of concave portions. In this way, the trace of the porous layer comprises fine concave portions arrayed regularly, the trace can be suitably used as an initiation site or points for forming nanoholes (which serves as an initiation site or points for forming nanoholes).

The porous layer can be removed by any suitable method according to the purpose and etching treatment using a solution containing chrome and phosphoric acid is preferred. In this case, when aluminum is used as the metallic matrix, only porous layer (alumite pore) formed by the first porous layer forming process is selectively removed.

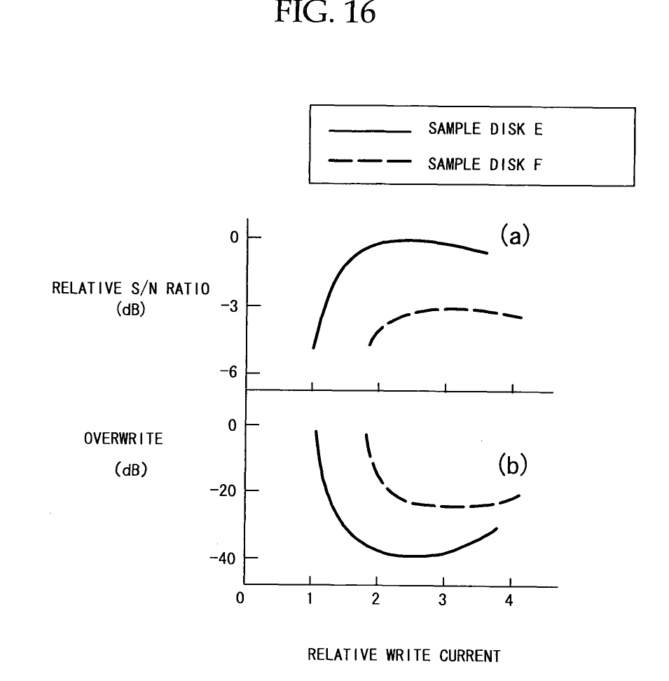

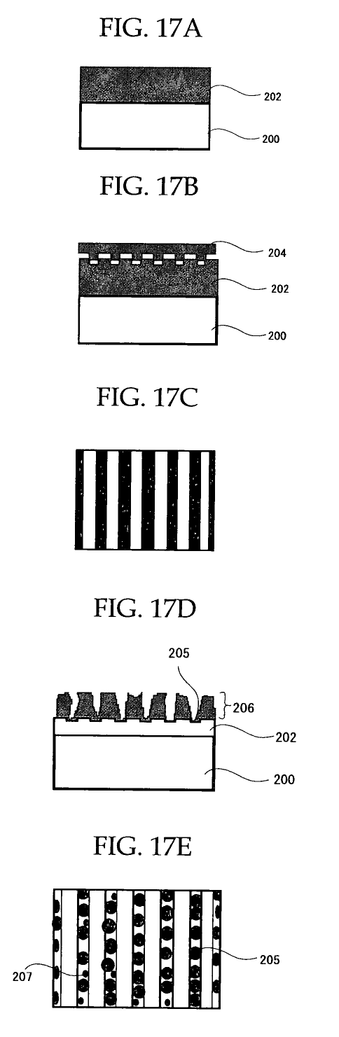

Here, the method for manufacturing a nanohole structure according to the present invention will be described with reference to the drawings. As shown in FIG. 17A, initially, a soft magnetic underlayer (not shown) is formed on a substrate 200 for magnetic disk which substrate has a plain surface by, for example, sputtering, and an aluminium film 202 having a thickness of 40 or more is formed. As shown in FIG. 17B, a nanopattern mold 204 made of high hardness material such as Ni and SiC is pressed at a pressure of 10,000 to 50, 000 N/cm² (1 to 5 Ton/cm²) and transferred to the aluminium film 202 to thereby form convex and concave patterns shown in FIG. 17C. Subsequently, as shown in FIG. 17D, by anodization, a porous layer (alumite pore) 206 comprising a plurality of nanoholes (alumina pores) extending in a direction substantially perpendicular to the substrate 200, is formed so as to have a thickness of 40 nm or more to 100 nm or less. At this time, as shown in FIG. 17E, surplus nanoholes (surplus alumina pores) 207 are scattered on the surface of the porous layer 206, causing some irregular intervals of arranged alumina pores 205. This corresponds to the first porous layer forming process.

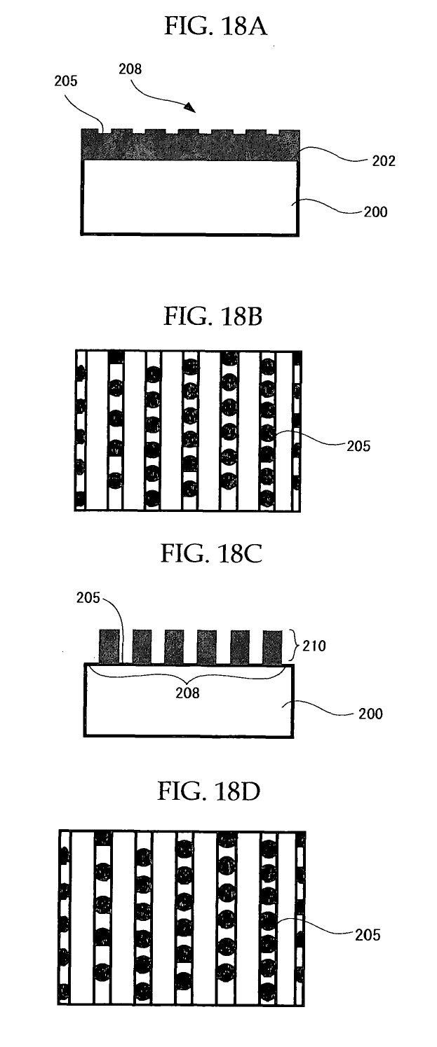

Next, as shown in FIG. 18A, etching treatment is performed using a solution containing chrome and phosphoric acid, and by selectively removing the porous layer 206 alone, the trace of the porous layer 208 comprising a plurality of fine convex portion is formed. At this time, as shown in FIG. 18B, in the trace of the porous layer 208, nanoholes (alumina pores) 205 as fine concave portions are arrayed regularly and formed in rows at specific intervals to constitute rows of nanoholes. This corresponds to the porous layer removing process.

By anodization using fine concave portions (alumina pores) 205 of the trace of the porous layer 208 as an initiation site or points for forming nanoholes, as shown in FIG. 18C, a nanohole structure (porous layer or alumite pore) 210 is formed on the trace of the porous layer 208 having a thickness of about 2 to 500 nm. As shown in FIG. 18D, the obtained nanohole structure 210 is an arrayed nanohole structure comprising nanoholes (alumina pores) 205 being arrayed regularly, wherein the nanoholes are formed in rows at specific intervals to constitute rows of nanoholes. This corresponds to the second porous layer forming process.

According to the method for manufacturing a nanohole structure of the present invention, the nanohole structure of the present invention can be efficiently manufactured at low cost.

### Stamper and Method for Manufacturing Thereof

The stamper of the present invention is obtained by the method for manufacturing a stamper of the present invention.

The method for manufacturing a stamper of the present invention includes a porous layer forming process, porous layer removing process and trace transferring process and further may include one or more of other processes suitably selected according to the necessity.

Hereinafter, the details of the stamper of the present invention will be made clear through description of the method for manufacturing a stamper of the present invention.

In the method for manufacturing a stamper of the present invention, the porous layer forming process and porous layer removing process correspond to the first porous layer forming process and porous layer removing process in the method for manufacturing a nanohole structure of the present invention, respectively, and the details thereof have been described above.

### Trace Transferring Process

The trace transferring process is a process where the trace of the porous layer obtained by the porous layer removing process is transferred to a stamper forming material.

The trace is the trace of the porous layer obtained by the porous layer removing process and comprises concave portions being arrayed regularly, which concave portions are formed in rows at specific intervals to constitute rows of concave portions. Since the trace comprises regularly arrayed fine concave portions, the trace can be suitably used as an initiation site or points for forming nanoholes (which serves as an initiation site or points for forming nanoholes).

The stamper forming material is not particularly limited and may be suitably selected according to the purpose. Examples thereof include photo-setting polymer, Ni, SiC, SiO₂ and the like. These may be used singly, or two or more may be used in combination. Ni is preferred from the viewpoint that it has high durability for continuous use and plurality of copies can easily be manufactured from one master using thick plating.

The photo-setting polymer is not particularly limited and may be suitably selected according to the purpose as long as it is hardened when exposed to light. Examples thereof include acrylic photo-setting resin, epoxy photo-setting resin and the like. Of these, acrylic photo-setting resin is preferred for it's excellent transferability and flowability.

It is preferable that the stamper forming material is selected according to the method of forming an initiation site or points for forming nanoholes on the metallic matrix. The initiation site or points for forming nanoholes can be formed by, for example, direct print, heat imprint, photo-imprint, etc. using the stamper of the present invention. Hereinafter, an example of theses methods will be described with reference to the drawings.

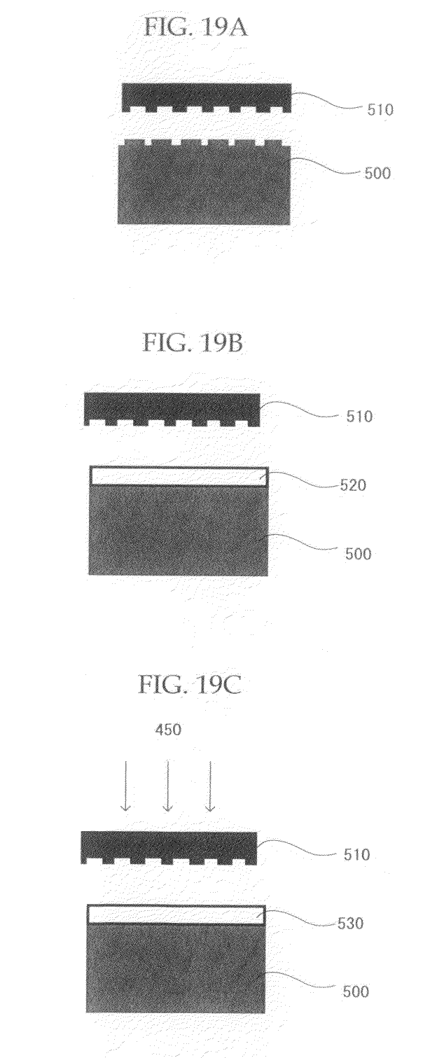

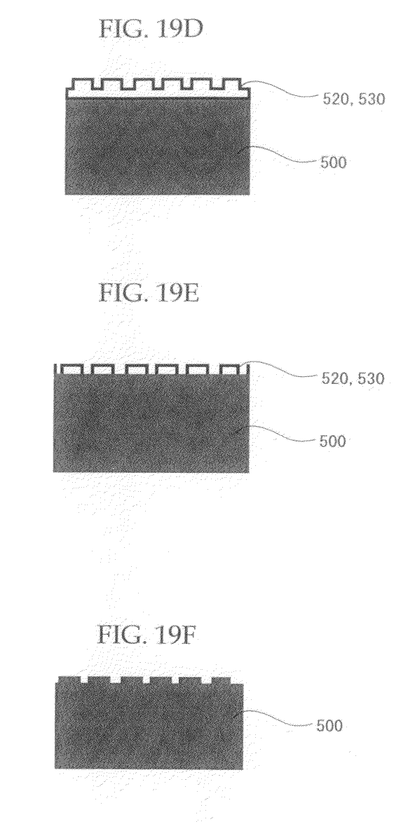

The method of forming an initiation site or points for forming nanoholes by the direct print is carried out in the following manner. As shown in FIG. 19A, the stamper of the present invention 510 is directly pressed onto the metallic matrix (e.g. aluminium) 500 at a high pressure of about 1 to 5 Ton/cm² to thereby form concave portions. In this case, the stamper forming material is preferably one having high hardness. For example, metal, SiC or the like is preferably used. Of these, metal is particularly preferred for easy duplication.

The method of forming an initiation site or points for forming nanoholes by the heat imprint is carried out in the following manner. As shown in FIG. 19B, a thermoplastic polymer layer 520 such as a resist and PMMA is arranged on the metallic matrix (e.g. aluminium) 500 and the stamper of the present invention 510 is pressed onto the thermoplastic polymer layer 520 at the softening point of the polymer or more (about 100° C. to about 200° C.) and at middle pressure (50 kg/cm² to 1 Ton/cm²) to thereby form concave portions. In this case, the stamper forming material is preferably one having high hardness or middle hardness and heat resistance. For example, metal, Si, SiC, SiO₂ or the like is preferably used. Of these, metal is particularly preferred for easy duplication.

The method of forming an initiation site or points for forming nanoholes by the photo-imprint is carried out in the following manner. As shown in FIG. 19C, a photopolymer layer 530 is arranged on the metallic matrix 500, the photopolymer layer 530 is exposed to ultraviolet light 450 via the stamper 510 of the present invention and patterned using the stamper 510 as a mask to thereby form concave portions. In this case, the stamper forming material is preferably a transparent one because it is required to transmit ultraviolet light. For example, SiO₂, polymer or the like is preferably used. Of these, polymer is particularly preferred for easy duplication.

In the method by the heat imprint and photo-imprint, as shown in FIG. 19D, the stamper 510 is peed off, as shown in FIG. 19E, a residue treatment or the like is carried out by O₂ plasma ashing, etc., and then, as shown in FIG. 19F, etching is carried out using chlorine dry system or chlorine wet system to thereby form concave portions on the metallic matrix 500.

The method for transferring the trace of the porous layer is not particularly limited and may be suitably selected according to the purpose. For example, when the stamper forming material is the photo-setting polymer, the trace can be transferred as follows. Specifically, for example, after a photo-setting polymer layer is formed by coating the photo-setting polymer on the trace on the metallic matrix, a transparent glass plate is placed thereon and the photo-setting polymer layer is exposed to ultraviolet light via the transparent glass plate, and then the metallic matrix is peeled off. Thus, fine concave portions which are regularly arrayed in the trace of the porous layer is transferred to the hardened photo-setting polymer layer and fine convex portions which are capable of engaging with the concave portions and regularly arrayed, are formed. Then, a mold releasing agent is coated on the photo-setting polymer layer so as to have a thickness of about 0.2 nm or less, and again transfer to the photo-setting polymer layer is carried out by the same procedure, thus achieving reversal of convexity and concavity. The mold releasing agent is not particularly limited and may be suitably selected according to the purpose. Examples thereof include fluorine mold releasing agent and silicon mold releasing agent, but fluorine mold releasing agent is preferred for its excellent release properties. The photo-setting polymer layer comprising the fine convex portions, on which layer the mold releasing agent is coated, can be used as a photopolymer stamper of the present invention.

Next, metal is vapor-deposited on the surface of the photo-setting polymer layer where the trace is transferred as a result of reversal of convexity and concavity to thereby form a film of about 10 to 50 nm serving as a plating electrode. Since this metal electrode also works as the contact surface at the time of mold pressing, it is required to have low resistance and high hardness. For example, high hardness metals such as Ni, Ti and Cr are used. Of these, Cr is preferred for its high hardness.

Furthermore, after thick metal plating is carried out on the surface of the photo-setting polymer to which the trace is transferred and the electrode is vapor-deposited so as to have a thickness of about 200 to 10,000 μm, the photo-setting polymer layer is peed off to thereby prepare the stamper made of metal of present invention. As the metal, metals which are easily manufactured by plating and have high hardness such as Ni, Cr or the like are suitably used, but Ni is particularly preferred from the viewpoint that it can be easily thick plated.

The stamper of the present invention obtained by the method for manufacturing a stamper of the present invention preferably comprises circular convex portions arrayed regularly, which are spaced in rows at specific intervals, and its material, shape, configuration, size and other parameters are selected according to the purpose.

The convex portion can have any suitable height. When the nanohole structure which is formed by the stamper is used in the magnetic recording medium such as a hard disk, the height is preferably 10 nm or more and more preferably from 20 to 100 nm. If the convex portion has a height less than 10 nm, at the time of transferring to a surface of aluminium film, the initiation points of nanoholes may not be fully restricted, inviting irregularity in the nanohole array to be obtained. In contrast, if a ratio of the height of convex portion to the intervals between convex portions (aspect ratio) is too high, a convex portion of the mold may easily become deformed and fracture at the time of transferring. Therefore, the aspect ratio is preferably 1.2 or less, i.e., when the pitch of nanoholes is 10 to 50 nm, the concave portion preferably has a height of 20 to 100 nm.

The coefficient of variation of the intervals between adjacent concave portions is not particularly limited and may be suitably selected according to the purpose. Smaller coefficient of variation is more preferred. When the nanohole structure which is manufactured using the stamper is used in the magnetic recording medium such as a hard disk, the coefficient of variation is preferably 10% or less, more preferably 5% or less and particularly preferably 0%.

If the coefficient of variation exceeds 10%, periodicity of magnetic signal pulse from each of the isolated magnetic material decrease, inviting deterioration of signal-to-noise ratios.

The coefficient of variation represents variation of measured value to the average value. The measuring method is, for example, by measuring center-to-center distance of adjacent convex portions arrayed in a row and the coefficient of variation is obtained by calculating according to the following equation:

CV(%)=σ/<X>×100

wherein CV is the coefficient of variation; σ is standard deviation; and <X> is mean.

The stamper of the present invention comprises circular convex portions arrayed regularly, which convex portions are spaced in rows at specific intervals. Therefore, when the nanohole structure is formed using the stamper of the present invention, the nanohole structure comprising ideal array of nanoholes can be manufactured easily and efficiently, and the stamper of the present invention can be suitably used for the method for manufacturing the nanohole structure of the present invention.

### Magnetic Recording Medium

The magnetic recording media according to the present invention comprise a substrate and a porous layer and may further comprise any other layers selected according to necessity.

The porous layer preferably comprises a plurality of nanoholes extending in a direction substantially perpendicular to the substrate plane and is preferably the above-mentioned nanohole structure. The details of the nanohole structure have been described above.

The thickness of the porous layer can be any suitable one set according to the purpose and is, for example, preferably 500 nm or less and more preferably from 5 to 200 nm.

A thickness of the porous layer exceeding 500 nm may prevent satisfactory charging of a magnetic material into the nanoholes.

The nanoholes in the porous layer (nanohole structure) may be through holes penetrating the porous layer or pits (recessed portions) not penetrating the porous layer. In the case where a magnetic material is charged into the nanohole to form a magnetic layer, and another magnetic layer is further formed under the former magnetic layer, the nanoholes are preferably through holes.

The nanoholes are preferably filled with at least one magnetic material to form at least one magnetic layer inside thereof.

The magnetic layer(s) can be any suitable one according to the purpose and may be, for example, a ferromagnetic layer and a soft magnetic layer. It is preferred that the soft magnetic layer and the ferromagnetic layer are arranged inside the nanoholes in this order from the substrate. Where necessary, a nonmagnetic layer (interlayer) may be formed between the ferromagnetic layer and the soft magnetic layer.

The substrate can have any suitable shape, structure and size and comprise any suitable material according to the purpose. The substrate preferably has a disk shape when the magnetic recording medium is a magnetic disk such as hard disk. It can have a single layer structure or a multilayer structure. The material can be selected from known materials for substrates of magnetic recording media and can be, for example, aluminium, glass, silicon, quartz or SiO₂/Si comprising a thermal oxide film on silicon. Each of these materials can be used alone or in combination.

The substrate can be suitably prepared or is available as a commercial product.

The ferromagnetic layer functions as a recording layer in the magnetic recording medium and constitutes magnetic layers together with the soft magnetic layer.

The ferromagnetic layer can be formed from any suitable material according to the purpose, such as Fe, Co, Ni, FeCo, FeNi, CoNi, CoNiP, FePt, CoPt and NiPt. These materials can be used alone or in combination.

The ferromagnetic layer can be any suitable layer formed from the material as a perpendicularly magnetized film. Suitable examples thereof are one having a L1₀ ordered structure with the C axis oriented in a direction perpendicular to the substrate plane, and one having a fcc structure or bcc structure with the C axis oriented in a direction perpendicular to the substrate plane.

The ferromagnetic layer can have any suitable thickness that does not adversely affect the advantages of the present invention and can be set depending on, for example, the linear recording density. The thickness is preferably (1) equal to or less than the thickness of the soft magnetic layer; (2) one-thirds to three times the minimum bit length determined by the linear recording density; or (3) equal to or less than the total thickness of the soft magnetic layer and the soft magnetic underlayer. It is generally preferably from about 5 to about 100 nm, and more preferably from about 5 to 50 nm. It is preferably 50 nm or less (around 20 nm) in magnetic recording at a linear recording density of 1500 kBPI at a target density of 1 Tb/in².

The thickness of the “ferromagnetic layer” means a total of individual ferromagnetic layers when the ferromagnetic layer comprises plural continuous layers or plural separated layers, for example, in the case where the ferromagnetic layer is partitioned by one or more interlayers such as nonmagnetic layers and constitutes discontinuous separated ferromagnetic layers. The thickness of the “soft magnetic layer” means a total thickness of individual soft magnetic layers when the soft magnetic layer comprises plural continuous layers or plural separated layers, for example, in the case where the soft magnetic layer is partitioned by one or more interlayers such as nonmagnetic layers and constitutes discontinuous soft magnetic layers. The “total thickness of the soft magnetic layer and the soft magnetic underlayer” means a total of individual soft magnetic layers and soft magnetic underlayers when at least one of the soft magnetic layer and the soft magnetic underlayer comprises plural continuous layers or plural separated layers, for example, in the case where the soft magnetic layer or the soft magnetic underlayer is partitioned by one or more interlayers such as nonmagnetic layers and constitutes discontinuous soft magnetic (under) layers.

According to the magnetic recording media of the present invention, the distance between the single pole head and the soft magnetic layer in magnetic recording can be less than the thickness of the porous layer and substantially equal to the thickness of the ferromagnetic layer. Thus, the convergence of a magnetic flux from the single pole head and the optimum properties for magnetic recording and reproduction at a recording density in practice can be controlled only by controlling the thickness of the ferromagnetic layer, regardless of the thickness of the porous layer. The magnetic recording media exhibit significantly increased write efficiency, require a decreased write current and have markedly improved overwrite properties as compared with conventional equivalents.

The ferromagnetic layer can be formed according to any suitable procedure such as electrodeposition.

The soft magnetic layer can be formed from any suitable material according to the purpose, such as NiFe, FeSiAl, FeC, FeCoB, FeCoNiB and CoZrNb. These materials can be used alone or in combination.

The soft magnetic layer can have any suitable thickness that does not adversely affect the advantages of the present invention and is selected according to the depth of nanoholes in the porous layer and the thickness of the ferromagnetic layer. For example, (1) the thickness of the soft magnetic layer or (2) the total thickness of the soft magnetic layer and the soft magnetic underlayer may be larger than the thickness of the ferromagnetic layer.

The soft magnetic layer advantageously serves to converge a magnetic flux from the magnetic head in magnetic recording effectively to the ferromagnetic layer to thereby increase the vertical component of magnetic field of the magnetic head. The soft magnetic layer and the soft magnetic underlayer preferably constitute a magnetic circuit of a recording magnetic field supplied from the magnetic head.

The soft magnetic layer preferably has an axis of easy magnetization in a direction substantially perpendicular to the substrate plane. Thus, in magnetic recording using a perpendicular-magnetic-recording head, the convergence of a magnetic flux from the perpendicular-magnetic-recording head and the optimum properties for magnetic recording and reproduction at a recording density in practice can be controlled and the magnetic flux converges to the ferromagnetic layer. As a result, the magnetic recording media exhibit significantly increased write efficiency, require a decreased write current and have markedly improved overwrite properties as compared with conventional equivalents.

The soft magnetic layer can be formed according to any suitable procedure such as electrodeposition.

The nanoholes in the porous layer may further include a nonmagnetic layer (interlayer) between the ferromagnetic layer and the soft magnetic layer. The nonmagnetic layer (interlayer) works to reduce the action of an exchange coupling force between the ferromagnetic layer and the soft magnetic layer to thereby control and adjust the reproduction properties in magnetic recording at desired levels.

The material for the nonmagnetic layer can be any suitable one selected from conventional materials such as Cu, Al, Cr, Pt, W, Nb, Ru, Ta and Ti. These materials can be used alone or in combination.

The nonmagnetic layer can have any suitable thickness according to the purpose.

The nonmagnetic layer can be formed according to any suitable procedure such as electrodeposition.

The magnetic recording media may further comprise a soft magnetic underlayer between the substrate and the porous layer.

The soft magnetic underlayer can be formed from any suitable material such as those exemplified as the materials for the soft magnetic layer. Each of these materials can be used alone or in combination. The material for the soft magnetic underlayer can be the same as or different from that for the soft magnetic layer.

The soft magnetic underlayer preferably has its axis of easy magnetization in an in-plane direction of the substrate. Thus, a magnetic flux from the magnetic head for recording effectively closes to form a magnetic circuit to thereby increase the vertical component of the magnetic field of the magnetic head. The use of the soft magnetic underlayer is also effective in recording in single domain at a bit size (diameter of opening of the nanoholes) of 100 nm or less.

The soft magnetic underlayer can be formed according to any suitable procedure such as electrodeposition or electroless plating.

The magnetic recording media may further comprise one or more other layers according to the purpose, such as an electrode layer and protective layer.

The electrode layer works as an electrode in the formation of the magnetic layer (including the ferromagnetic layer and the soft magnetic layer) typically by electrodeposition and is generally arranged between the substrate and the ferromagnetic layer. To form the magnetic layer by electrodeposition, the electrode layer as well as the soft magnetic underlayer or another layer can be used as the electrode.

The electrode layer can be formed from any suitable material according to the purpose, such as Cr, Co, Pt, Cu, Ir, Rh, and alloys thereof. Each of these can be used alone or in combination. The electrode layer may further comprise any of other substances such as W, Nb, Ti, Ta, Si and O in addition to the aforementioned materials.

The electrode layer can have any suitable thickness according to the purpose. The magnetic recording media may comprise one or more of such electrode layers.

The electrode layer can be formed according to any suitable procedure such as sputtering or vapor deposition.

The protective layer works to protect the ferromagnetic layer and is arranged on or above the ferromagnetic layer. The magnetic recording media may comprise one or more of such protective layers which have a single-layer structure or multilayer structure.

The protective layer can be formed from any suitable material according to the purpose, such as diamond-like carbon (DLC).

The protective layer can have any suitable thickness according to the purpose.

The protective layer can be formed according to any suitable procedure, such as plasma CVD or coating.

The magnetic recording media can be used in various magnetic recording systems using a magnetic head, are useful in magnetic recording using a single pole head and are typically useful in the magnetic recording apparatus and magnetic recording method according to the present invention mentioned later.

The magnetic recording media enable recording of information at high density and high speed with a high storage capacity without increasing a write current of the magnetic head, exhibit satisfactory and uniform properties such as overwrite properties and are of very high quality. Thus, they can be designed and used as a variety of magnetic recording media. For example, they can be designed and used as magnetic disks such as hard disks in hard disk devices widely used as external storage for computers and consumer-oriented video recorders.

The magnetic recording media can be manufactured by any suitable method and are preferably manufactured by the method for manufacturing a magnetic recording medium according to the present invention, mentioned below.

### Method for Manufacturing Magnetic Recording Media

The method for manufacturing a magnetic recording medium according to the present invention is a method for manufacturing the magnetic recording media of the present invention. The method includes a nanohole structure forming process (porous layer forming process), a magnetic material charging process and preferably a polishing process and may further include one or more of other processes such as a soft magnetic underlayer forming process, electrode layer forming process, nonmagnetic layer forming process, and protective layer forming process.

The soft magnetic underlayer forming process is carried out according to necessity, in which a soft magnetic underlayer is formed on or above a substrate.

The substrate can be any of the above-mentioned substrates.

The soft magnetic underlayer can be formed according to a conventional procedure such as sputtering, vapor deposition or another vacuum film forming procedure, as well as electrodeposition or electroless plating.

According to the soft magnetic underlayer forming process, the soft magnetic underlayer is formed with a desired thickness on or above the substrate.

In the electrode layer forming process, an electrode layer is formed between the nanohole structure and the soft magnetic underlayer.

The electrode layer can be formed according to a conventional procedure, such as sputtering or vapor deposition, under any suitable conditions according to the purpose.

The electrode layer formed by the electrode layer forming process serves as an electrode in the formation of at least one of a soft magnetic layer, nonmagnetic layer and ferromagnetic layer by electrodeposition.

The nanohole structure forming process (porous layer forming process) comprises forming a metallic layer made of a metallic material on or above the substrate or the soft magnetic underlayer, if formed, and subjecting the metallic layer to a nanohole forming treatment such as anodization to form a plurality of nanoholes extending in a direction substantially perpendicular to the substrate plane to thereby form a nanohole structure (porous layer).

The metallic material can be any suitable one such as the above-mentioned metallic materials. Among them, alumina (aluminum oxide) and aluminium are preferred, of which aluminum is typically preferred.

The metallic layer can be formed according to any suitable procedure, such as sputtering or vapor deposition, under any suitable conditions according to the purpose. The sputtering can be carried out by using a target made of the metallic material. The target used herein preferably has a high purity, and when the metallic material is aluminum, preferably has a purity of 99.990% or more.

The nanohole forming treatment can be any suitable treatment according to the purpose, such as anodization or etching. Among them, anodization is typically preferred to form a plurality of uniform nanoholes in the metallic layer at substantially equal intervals, which nanoholes each extend in a direction substantially perpendicular to the substrate plane.

The anodization can be carried out by electrolyzing and etching the metallic layer in an aqueous solution of sulfuric acid, phosphoric acid or oxalic acid using an electrode on or above the metallic layer as an anode. The soft magnetic underlayer or the electrode layer which has been formed prior to the formation of the metallic layer can be used as the electrode.

It is preferred to form rows of concave portions for the formation of rows of nanoholes on a surface of the metallic layer before the anodization, as mentioned above. Thus, the nanoholes can be efficiently formed and spaced at specific intervals only on the rows of concave portions as a result of anodization.

The rows of concave portions can have any suitable sectional profile in a direction perpendicular to the longitudinal direction, such as a rectangular, V-shaped or semicircular profile.

The rows of concave portions can be formed by any suitable method according to the purpose. Examples of such methods are (1) a method in which a mold having a line-and-space pattern comprising lines of convex portions on its surface is imprinted and the pattern is transferred to the metallic layer made of, for example, alumina or aluminum to thereby form a line-and-space pattern comprising rows of concave portions and spaces arranged at specific intervals alternately, wherein the convex portions are preferably arranged concentrically or helically when the nanohole structure is used in the magnetic recording medium; (2) a method in which a resin layer or photoresist layer is formed on the metallic layer, is then patterned and etched to thereby form rows of concave portions on a surface of the metallic layer; and (3) a method in which grooves (rows of concave portions) are directly formed on a surface of the metallic layer.

The width of the rows of nanoholes can be varied at specific intervals in a longitudinal direction of the rows by periodically varying, for example, the width of the lines of convex portions in the mold or the width of the pattern of rows of concave portions formed in the photoresist layer at specific intervals in its longitudinal direction. Thus, the magnetic recording medium using the nanohole structure enables high-density recording with reduced jitter. In addition, the rows of concave portions are preferably partitioned in the longitudinal direction at specific intervals. Thus, the nanoholes can be formed in the partitioned portions in the rows of concave portions at substantially regular intervals.

The mold can be any suitable one according to the purpose but is preferably a silicon carbide substrate as well as a Ni stamper used in molding of optical disks for high durability in continuous use. The mold can be used a plurality of times. The imprint transfer can be carried out according to any conventional procedure according to the purpose. The resist material for the photoresist layer includes not only photoresist materials but also electron beam resist materials. The photoresist material for use herein can be any suitable material known in the field of semiconductors, such as materials sensitive to near-ultraviolet rays or near-field light.

The anodization can be carried out at any suitable voltage but preferably at such a voltage satisfying the following equation: V=I/A, wherein V is the voltage in the anodization; I is the interval (nm) between adjacent rows of nanoholes; and A is a constant (nm/V) of 1.0 to 4.0.

When the anodization is carried out at a voltage satisfying the above equation, the nanoholes are advantageously arranged in the rows of concave portions.

The anodization can be carried out under any suitable conditions including the type, concentration and temperature of an electrolyte and the time period for anodization according to the number, size and aspect ratio of the target nanoholes. For example, the electrolyte is preferably a diluted phosphoric acid solution at intervals (pitches) of adjacent rows of nanoholes of 150 nm to 500 nm, is preferably a diluted oxalic acid solution at a pitch of 80 nm to 200 nm, and is preferably a diluted sulfuric acid solution at a pitch of 10 nm to 150 nm. In any case, the aspect ratio of the nanoholes can be controlled by immersing the anodized metallic layer with a phosphate solution to thereby increase the diameter of the nanoholes such as alumina pores.

When the nanohole structure forming process (porous layer forming process) is carried out by the anodization, a plurality of nanoholes can be formed in the metallic layer. However, a barrier layer may be formed at the bottom of the nanoholes in some cases. The barrier layer can be easily removed according to a conventional etching procedure using a conventional etchant such as phosphoric acid. Thus, a plurality of the nanoholes can be formed in the metallic layer so as to extend in a direction substantially perpendicular to the substrate plane and to expose the soft magnetic underlayer or the substrate from the bottom thereof.

The nanohole structure forming process (porous layer forming process) forms the nanohole structure (porous layer) on or above the substrate or the soft magnetic underlayer.

The magnetic material charging process is a process for charging at least one magnetic material into the nanoholes in the nanohole structure (porous layer) and may comprise, for example, ferromagnetic layer forming process for charging the ferromagnetic material into the nanoholes, and/or a soft magnetic layer forming process for charging the soft magnetic material into the nanoholes.

According to the soft magnetic layer forming process, a soft magnetic layer is formed inside the nanoholes.

The soft magnetic layer can be formed, for example, by depositing or charging the material for the soft magnetic layer inside the nanoholes typically by electrodeposition.

The electrodeposition can be carried out according to any suitable procedure under any suitable conditions according to the purpose. It is preferably carried out by applying a voltage to a solution containing one or more of the materials for the soft magnetic layer using the soft magnetic underlayer or the electrode layer as an electrode and precipitating or depositing the material on the electrode.

As a result of the soft magnetic layer forming process, the soft magnetic layer is formed on or above the substrate, the soft magnetic underlayer or the electrode layer inside the nanoholes in the porous layer.

The ferromagnetic layer forming process is a process for forming a ferromagnetic layer on or above the soft magnetic layer or the nonmagnetic layer, if formed.

The ferromagnetic layer can be formed, for example, by depositing or charging the material for the ferromagnetic layer on or above the soft magnetic layer or the nonmagnetic layer inside the nanoholes typically by electrodeposition.

The electrodeposition can be carried out according to any suitable procedure under any suitable conditions according to the purpose. It is preferably carried out by applying a voltage to a solution containing one or more of the materials for the ferromagnetic layer using the soft magnetic underlayer or the electrode layer (seed layer) as an electrode and precipitating or depositing the material inside the nanoholes.

As a result of the ferromagnetic layer forming process, the ferromagnetic layer is formed on or above the soft magnetic layer or the nonmagnetic layer inside the nanoholes in the porous layer.

The nonmagnetic layer forming process is a process for forming a nonmagnetic layer on or above the soft magnetic layer.

The nonmagnetic layer can be formed, for example, by depositing or charging the material for nonmagnetic layer on or above the soft magnetic layer inside the nanoholes typically by electrodeposition.

The electrodeposition can be carried out according to any suitable procedure under any suitable conditions according to the purpose. It is preferably carried out by applying a voltage to a solution containing one or more of the materials for the nonmagnetic layer using the soft magnetic underlayer or the electrode layer as an electrode and precipitating or depositing the material inside the nanoholes.

As a result of the nonmagnetic layer forming process, the nonmagnetic layer is formed adjacent typically to the soft magnetic layer inside the nanoholes in the porous layer.

The polishing process is a process for polishing and flattening a surface of the nanohole structure (porous layer). By removing the surface of the nanohole structure by a certain thickness in the polishing process, higher-density recording and higher-speed recording can be assured, and by flattening the surface of the magnetic recording medium in the polishing process, the magnetic head such as a perpendicular-magnetic-recording head can stably float closely over the medium to thereby realize high-density recording with good reliability.

The polishing process is preferably carried out after the magnetic layer forming process including the ferromagnetic layer forming process and the soft magnetic layer forming process. When the polishing is carried out before the magnetic layer forming process, the nanohole structure may be destroyed and slurry, chips, etc. are discharged inside the nanoholes, inviting plating failure.

The polishing amount in the polishing process is preferably 15 nm or more of thickness, more preferably 40 nm or more of thickness from the uppermost surface of the nanohole structure (porous layer).

If the polishing amount is 15 nm or more, the layer which comprises surplus nanoholes (alumina pores) existing in the vicinity of the surface of the nanohole structure and where alumina pores are arranged at irregular intervals, can be removed, and on the surface of the nanohole structure after polishing, the nanoholes can be arrayed regularly and formed in rows at specific intervals to constitute rows of nanoholes.

In the polishing process, the surface of nanohole structure can be polished according to any suitable procedure. Suitable examples thereof include CMP and ion milling.

According to the method of the present invention, the magnetic recording media of the present invention can be efficiently manufactured at low cost.

### Magnetic Recording Apparatus and Method

The magnetic recording apparatus according to the present invention comprises the magnetic recording medium of the present invention and a perpendicular-magnetic-recording head and may further comprise one or more other means or members according to necessity.

The magnetic recording method according to the present invention comprises the process for recording information on the magnetic recording medium of the present invention using a perpendicular-magnetic-recording head and may further comprise one or more other treatments or processes according to necessity. The magnetic recording method is preferably carried out using the magnetic recording apparatus of the present invention. The other treatments or processes can be carried out using the other means or members. The magnetic recording apparatus as well as the magnetic recording method will be illustrated below.

The perpendicular-magnetic-recording head can be any suitable one selected according to the purpose and is preferably a single pole head. The perpendicular-magnetic-recording head may be a write-only head or a read/write head integrated with a read head such as a giant magneto-resistive (GMR) head.

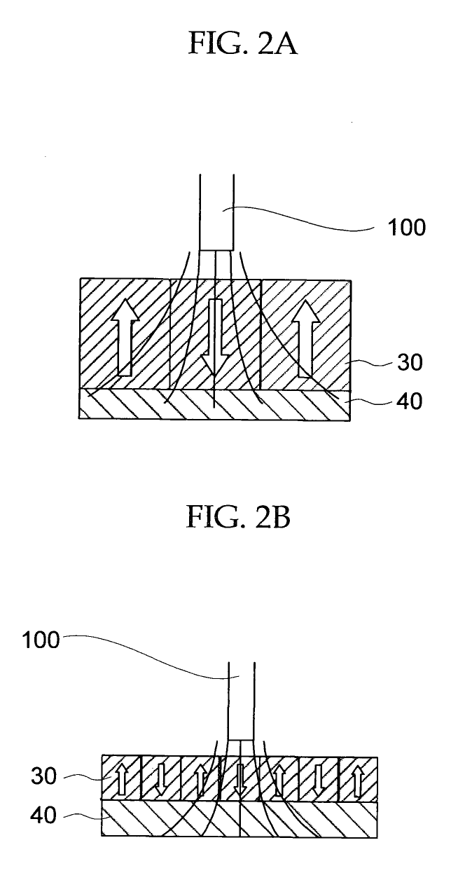

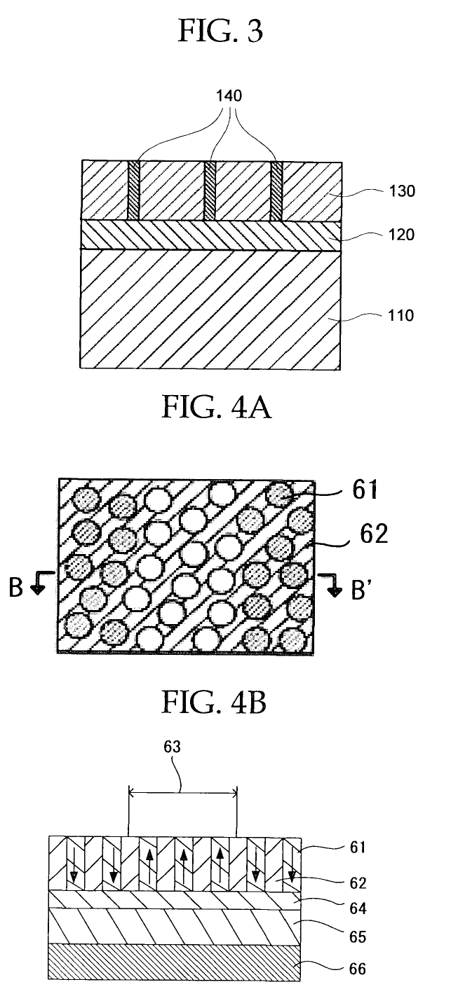

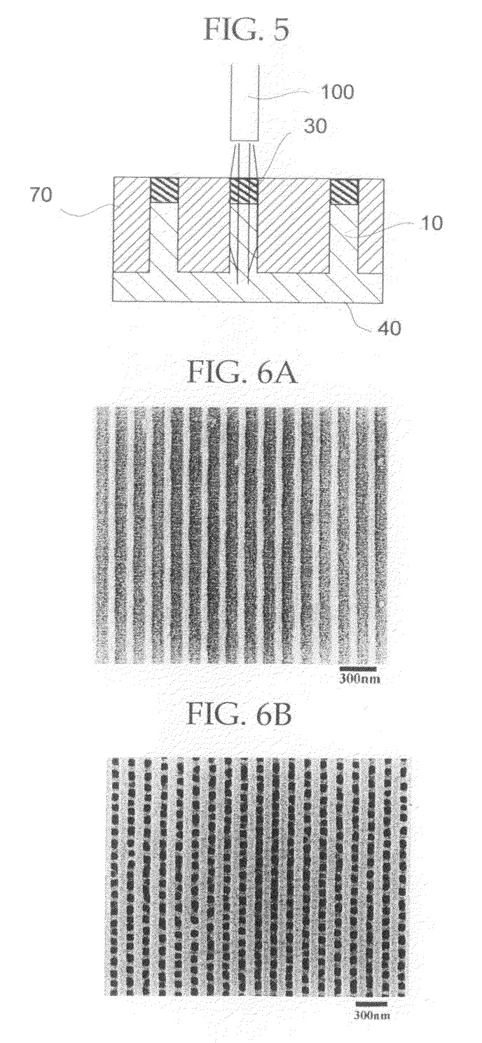

In the magnetic recording apparatus or the magnetic recording method, the magnetic recording medium of the present invention is used in magnetic recording. Thus, the distance between the perpendicular-magnetic-recording head and the soft magnetic layer in the magnetic recording medium is less than the thickness of the porous layer and is substantially equal to the thickness of the ferromagnetic layer. The convergence of a magnetic flux from the perpendicular-magnetic-recording head and the optimum properties for magnetic recording and reproduction at a recording density in practice can therefore be controlled only by controlling the thickness of the ferromagnetic layer, regardless of the thickness of the porous layer. As shown in FIG. 2B, the magnetic flux from a main pole of the perpendicular-magnetic-recording head (write/read head) 100 converges to the ferromagnetic layer (perpendicularly magnetized film) 30. As a result, the magnetic recording apparatus (method) exhibits significantly increased write efficiency, requires a decreased write current and has markedly improved overwrite properties as compared with conventional equivalents.

It is preferred that the magnetic recording medium further comprises the soft magnetic underlayer for higher recording density, because the perpendicular-magnetic-recording head and the soft magnetic underlayer constitute a magnetic circuit.

According to the magnetic recording apparatus or the magnetic recording method, the magnetic flux from the perpendicular-magnetic-recording head does not diverge but converges to the ferromagnetic layer in the magnetic recording medium even at the bottom thereof, i.e., at the interface with the soft magnetic layer or the nonmagnetic layer. Thus, information can be recorded in small bits.

The magnetic flux can converge in the ferromagnetic layer at any suitable degree of convergence (degree of divergence) within a range not deteriorating the advantages of the present invention.

The present invention will be illustrated in further detail with reference to several examples below, which are not intended to limit the scope of the present invention. In the following examples, the magnetic recording medium comprising the nanohole structure is manufactured by the method of the present invention, and information is recorded thereon using the magnetic recording apparatus of the present invention to carry out the magnetic recording method of the present invention.

### Preparation Test Example of Nanohole Structure

A mold having a line-and-space pattern at a pitch of 150 nm was pressed onto an aluminum layer to thereby imprint and transfer the pattern comprising lines (concave portions or grooves) and spaces (convex portions or lands) to the aluminum layer. Thus, a linear convex-and-concave pattern comprising rows of concave portions arranged at specific intervals were formed (FIG. 6A). The aluminum layer was then anodized at a voltage of 60V in a diluted solution of oxalic acid to thereby form nanoholes (alumina pores) only in the rows of concave portions, which nanoholes were arranged in their longitudinal direction in a self-organization manner (FIG. 6B). Namely, rows of nanoholes were formed.

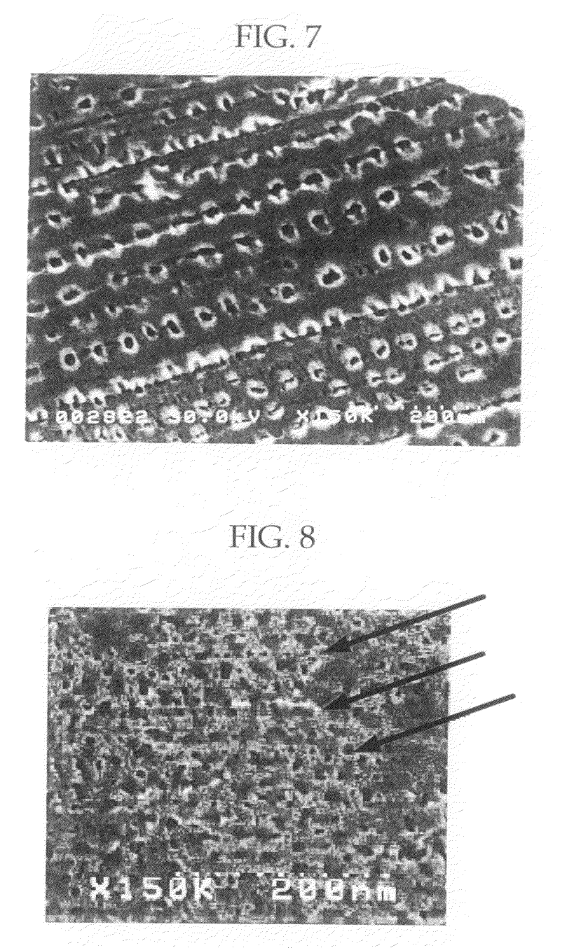

Separately, a surface of another piece of the aluminum layer was scratched to form scratches thereon at intervals of 40 to 90 nm instead of imprint transfer of the line-and-space pattern. This aluminum layer having the scratches was anodized at 16° C. at a voltage of 25 V in a 0.3 mol/l diluted solution of sulfuric acid to thereby form nanoholes (alumina pores) along the scratches (FIG. 7). Namely, rows of nanoholes were formed. The nanoholes were typically formed along the scratches at intervals of 60 nm.

An attempt was made to reduce the intervals between the rows of nanohole. Specifically, lines at intervals of 20 nm were formed on another piece of the aluminum layer; and the aluminum layer was then anodized at a voltage of 8 V in a diluted solution of sulfuric acid to thereby form rows of nanoholes at intervals of about 20 nm, in which nanoholes (alumina pores) were spaced in rows (FIG. 8). These results show that the intervals (pitches) of the rows of nanoholes are proportional to the voltage in anodization and can be reduced to about 20 nm.

### Example 1

### Preparation of Nanohole Structure

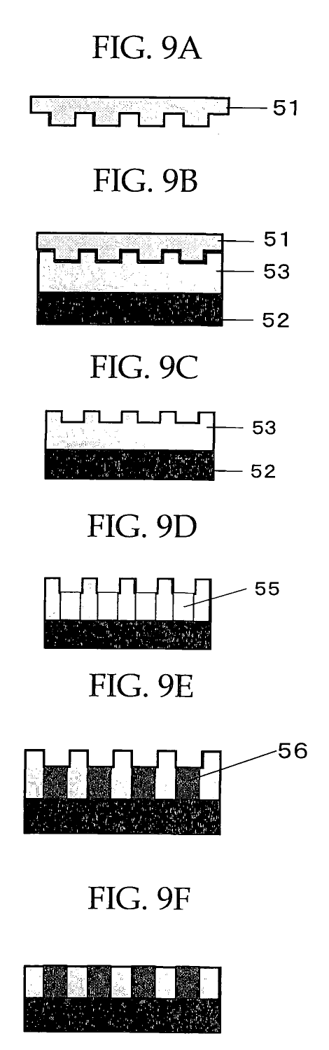

A nanohole structure was prepared by the processes shown in FIGS. 9A to 9D. Initially, a resist layer 40 nm thick was formed on a glass substrate 52 by spin coating. A helical (spiral) line pattern was formed on the resist layer along a circumferential direction using a deep UV aligner (wavelength: 257 nm) to thereby form each of convex-and-concave patterns shown in Table 1. Each of the convex and concave patterns had an interval (pitch) between rows of concave portions of 1 mm and a depth of the rows of concave portions of 40 nm. A Ni layer was then formed on a surface of each convex and concave pattern by sputtering, the nickel layer as an electrode was subjected to electroforming in a nickel sulfamate bath to a thickness of the nickel layer of 0.3 mm, and the backside of the substrate was polished to thereby yield a series of Ni stamper molds 51 (FIG. 9A; mold preparation process).

Next, each of the above-prepared Ni stamper molds was pressed to an aluminum substrate 53 to thereby imprint and transfer each convex and concave pattern on the Ni stamper mold to a surface of the aluminum substrate 53 (FIGS. 9B and 9C; imprint process). The aluminum substrate 53 had a five-nines purity and had a flattened surface as a result of electrolytic polishing. The pressure in the imprint transfer was set at 3,000 kg/cm².

The aluminum substrate after imprint-transfer was anodized in a diluted phosphoric acid bath (FIG. 9D; anodization process). The voltage in the anodization was varied as shown in Table 1. The formed nanoholes (alumina pores) 55 were observed by scanning electron microscope. The results are shown in Table 1.

TABLE 1

| Pattern | | | | | | | | |
|---|---|---|---|---|---|---|---|---|
| | Pitch | Width ratio of convex | Depth of concave | Anodization voltage (V) | | | | |
| No. | (nm) | portion to concave portion | portion (nm) | 320 | 200 | 120 | 80 | 40 |
| A | 800 | 0.5 | 40 | Failure | | | | |
| B | 500 | 0.5 | 40 | | Good | Failure | | |
| C-1 | 300 | 0.1 | 40 | | | Fair | | |
| C-2 | 300 | 0.2 | 40 | | | Good | | |
| C-3 | 300 | 0.5 | 40 | | Failure | Good | Failure | |
| C-4 | 300 | 0.8 | 40 | | | Good | | |
| C-5 | 300 | 1 | 40 | | | Failure | | |
| C-6 | 300 | 1.2 | 40 | | | Failure | | |
| D | 200 | 0.5 | 40 | | | Failure | Good | Failure |

where, in Table 1, “Good”, “Fair” and “Failure” each represent the following condition.
Good: Rows of nanoholes comprising nanoholes (alumina pores) spaced in rows were formed in the concave portions.
Fair: Some of convex portions were broken and nanoholes (alumina pores) were fused with those in adjacent concave portions.
Failure: Nanoholes (alumina pores) were formed not only in concave portions but also in convex portions.

The results in Table 1 show that, for the formation of rows of nanoholes regularly only in concave portions, the voltage (V) in the anodization preferably satisfies the equation: V=I/A wherein V is the voltage; I is the interval or pitch (nm) between rows of nanoholes; and A is a constant (nm/V) of about 2.5; the interval (pitch) between the rows of concave portions is preferably 500 nm or less; and the ratio of the width of convex portions to the width of concave portions is preferably 0.2 to 0.8. In other words, the ratio of the interval to the width of concave portions is preferably from 1.2 to 1.8.

### Example 2

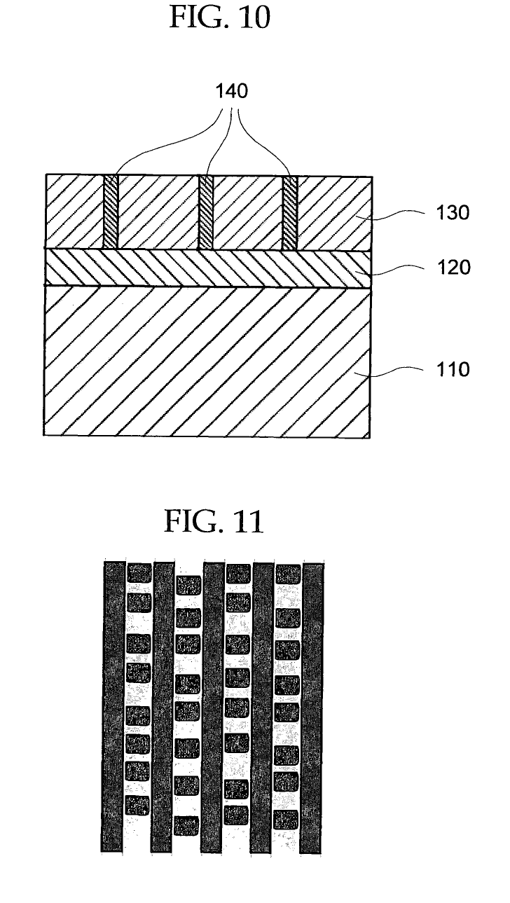

A mold was prepared by the procedure of Example 1, except for using an electron beam (EB) aligner instead of the deep UV aligner and for forming a helical pattern 60 nm wide of rows of concave portions at intervals (pitch) between rows of 100 nm. Separately, an aluminum layer 100 nm thick was formed by sputtering on a magnetic disk substrate made of silicon. The above-prepared mold was pressed to the aluminum layer to thereby imprint and transfer the pattern to the aluminum layer. The aluminum layer was then anodized at a voltage of 40 V in a diluted sulfuric acid solution to thereby form rows of nanoholes in which nanoholes (alumina pores) were spaced in rows at specific intervals on the rows of concave portions. Then, cobalt (Co) 56 was charged into individual nanoholes (alumina pores) in the rows of nanoholes by electrodeposition (FIG. 9E; magnetic meal electrodeposition process). The resulting article was observed by a scanning electron microscope to find to have a structure shown in FIG. 11. Nanoholes (alumina pores) filled with cobalt (Co) were spaced in rows along the rows of concave portions as in the case of FIG. 6B, but some irregularities were observed in their array.

### Example 3

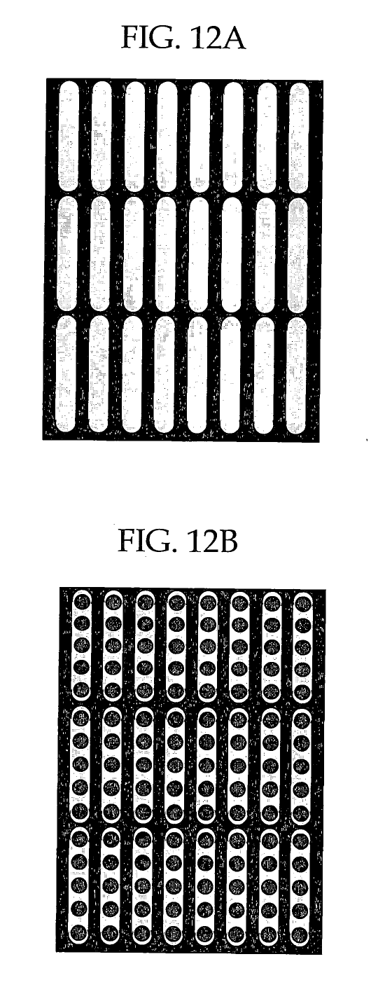

The procedure of Example 2 was repeated except that the pattern of the rows of concave portions was partitioned by a length of 500 nm in its longitudinal direction (FIG. 12A; mold). As a result, five nanoholes (alumina pores) were formed at substantially equal intervals in every partitioned region 500 nm long of the rows of concave portions (FIG. 12B; after electrodeposition of Co). The result shows that nanoholes (alumina pores) can be formed in a specific number in a more regular array by partitioning the pattern of the rows of concave portions at specific intervals, as compared with a continuous pattern of the rows of concave portions.

### Example 4

The procedure of Example 2 was repeated except that a mold was prepared to have rows of concave portions with a varying width at intervals of 100 nm in its circumferential direction (FIG. 13A; mold) by periodically modulating the exposure power in electron beam application in a circumferential direction. The resulting nanohole structure was observed by a scanning electron microscope by the procedure of Example 2 to find that it had a structure shown in FIG. 13B (after electrodeposition of Co) in which nanoholes (alumina pores) filled with cobalt (Co) were formed regularly in portions having a wide width in the rows of concave portions.

### Example 5

A magnetic recording medium (magnetic disk) having the nanohole structure was prepared and properties of the disk were determined in the following manner.

### Soft Magnetic Underlayer Forming Process

A layer of FeCoNiB was formed onto a glass substrate by electroless plating to form a soft magnetic underlayer 500 nm thick. Nanohole Structure Forming Process (Porous Layer Forming Process)

The nanohole structure forming process was carried out in the following manner. A film of Nb 5 nm thick and a film of A1 150 nm thick were formed onto the soft magnetic underlayer by sputtering, respectively in this order to form three plies of multilayer substrates. The respective molds having a convex-concave line pitch in a radial direction of 100 nm prepared according to Examples 2 to 4 were pressed to the surface aluminum (Al) layer of the substrate to thereby imprint and transfer the rows of concave portions.

Each of the three samples after imprint-transfer was subjected to anodization at a voltage of 40 V in a 0.3 mol/l oxalic acid solution at a bath temperature of 20° C. to thereby form nanoholes (alumina pores). After the anodization, each of the samples was immersed in a bath of a 5 percent by weight phosphoric acid solution at a bath temperature of 30° C. to increase the diameter of opening of the nanoholes (alumina pores) to 40 nm to thereby control the aspect ratio. Thus, the nanohole structure forming process was carried out.

### Magnetic Material Charging Process

The magnetic material charging process was carried out by carrying out electrodeposition inside the nanoholes using a plating bath comprising 5 percent by weight copper sulfate solution and 2 percent by weight boric acid solution at a bath temperature of 35° C. to thereby charge cobalt (Co) into the nanoholes to form a ferromagnetic layer inside thereof. Thus, a series of magnetic disks was manufactured.

### Polishing Process

The polishing process (FIG. 9F) was carried out in the following manner. The surface of the magnetic disk was polished using lapping tapes in order to float the magnetic head. More specifically, the alumina in convex portions exposed from the openings of the nanoholes was roughly polished using an alumina tape having a particle size of 3 μm and was then finish-polished using an alumina tape having a particle size of 0.3 μm. The porous layer (alumina layer) after the polishing process had a thickness of about 100 nm and the nanoholes filled with the cobalt (Co) had an aspect ratio of about 2.5.

Next, a film of perfluoropolyether (AM3001, available from Solvay Solexis) was applied to the polished surface of the magnetic disk by dipping to thereby form a series of magnetic disk test samples.

The magnetic disk test samples having a structure shown in FIG. 10 prepared by using the molds according to Examples 2, 3 and 4 were taken as Sample Disks A, B, and C. Separately, a comparative magnetic disk was manufactured by the above procedure except that imprint transfer using a mold was not carried out, to thereby yield Sample Disk D. In Sample Disk D, the nanoholes (alumina pores) were not spaced in rows but spread two-dimensionally in the form of a lattice of hexagonal closest packing shown in FIG. 4A.

The magnetic properties of Sample Disks A, B, C and D were determined by using a merge type magnetic head mentioned below comprising a monopole write head for perpendicular recording and a GMR read head. The head parameters are as follows.

Write Core Width: 60 nm

Write Pole Length: 50 nm

Read Core Width: 50 nm

Read Gap Length: 60 nm

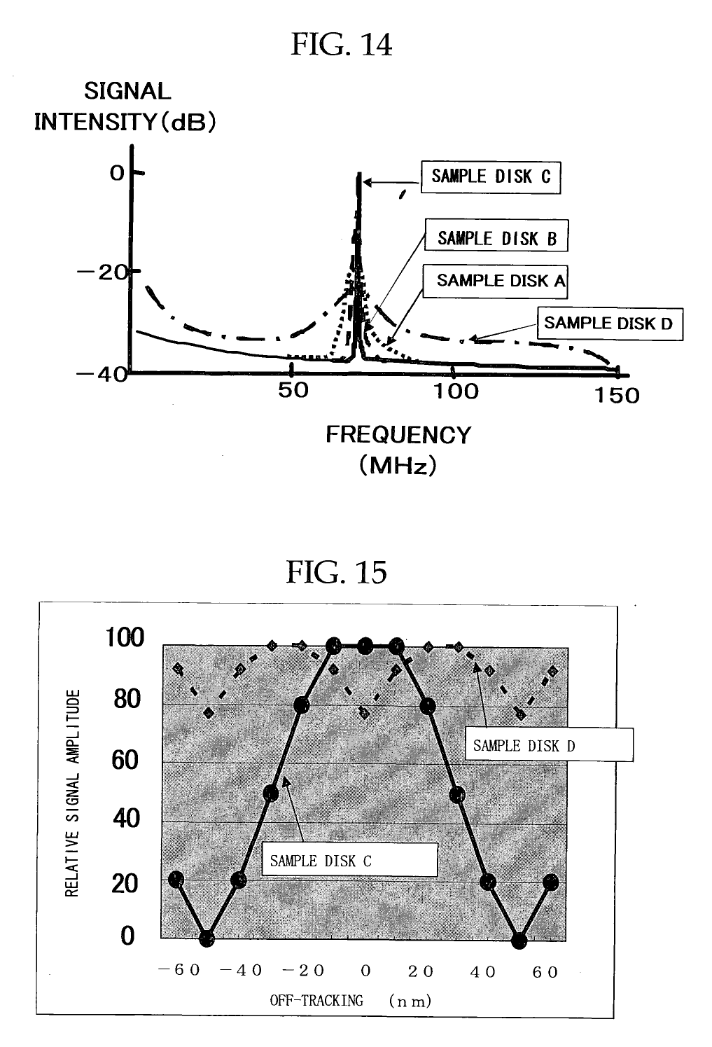

Initially, each of Sample Disks A, B, C and D was magnetized in a direction perpendicular to the substrate plane using a permanent magnet. Then, a magnetic head was floated while rotating each disk at a peripheral speed of 7 m/s, and the readout waveform was observed. FIG. 14 shows the frequency analyses of the readout waveforms by a spectrum analyzer.

Each of Sample Disks A, B, C and D showed a spectrum with a peak at 71 MHz corresponding to the period of 100 nm and the peripheral speed of 7 m/s. More specifically, Sample Disk C having a configuration corresponding to FIG. 13B exhibits a sharp peak, indicating that the nanoholes (alumina pores) are spaced in rows at regular intervals. Sample Disk B having a configuration corresponding to FIG. 12B exhibits a relatively sharp peak. Sample Disk A having a configuration corresponding to FIG. 11 exhibits a relatively broad spectrum dispersion due to somewhat irregular intervals between the nanoholes (alumina pores).

In contrast, Sample Disk D having two-dimensionally spread nanoholes corresponding to FIG. 4A exhibits a broad spectrum distribution extending to about 150 MHz, because a 50-nm periodic structure as well as the 100-nm periodic structure are detected.

These results show that, in the arrays of nanoholes (alumina pores) corresponding to FIGS. 12B and 13B, nanoholes (alumina pores), i.e., magnetic dots, are much regularly spaced in rows in a circumferential direction at specific intervals.

To verify the advantages of partitioning of rows of nanoholes each comprising magnetic dots partitioned by nonmagnetic regions, the signal amplitudes of Sample Disks C and D were determined while off-tracking in reading. The results are shown in FIG. 15.

FIG. 15 shows that Sample Disk C, in which magnetic dots spaced in a line in one track, and tracks are separated from each other by a nonmagnetic region, exhibits a rapidly reduced signal amplitude with off-tracking, indicating that signals in adjacent tracks are separated nearly perfectly.

In contrast, Sample Disk D, in which magnetic dots are spread two dimensionally, shows substantially no reduction in signal amplitude even with off-tracking, indicating that signals between adjacent tracks are not separated.

These results show that the magnetic recording media (magnetic disks) according to the present invention enables high-density tracks, can read out magnetic dots in a circumferential direction clearly separately, enables recording and reproduction of one bit in one dot and thus enables high-density recording.

### Example 6

A magnetic recording medium according to the present invention was manufactured in the following manner. Initially, a film of CoZrNb as a material for the soft magnetic underlayer was formed on a silicon substrate serving as the substrate by sputtering, to thereby form the soft magnetic underlayer 500 nm thick. This process is the soft magnetic underlayer forming process in the method for manufacturing the magnetic recording medium according to the present invention.

Next, an aluminum layer was formed on the soft magnetic underlayer by sputtering using aluminum (Al) with a purity of 99.995% as the target to thereby form the metallic layer 500 nm thick. The metallic layer was anodized by the procedure of Example 5, except for using the soft magnetic underlayer (CoZrNb) as an electrode, to thereby form nanoholes (alumina pores) in the metallic layer (aluminum layer). The nanoholes (alumina pores) had a diameter of opening of 40 nm, an aspect ratio of 12.5 and were spaced concentrically at specific intervals (pitches) to constitute rows of nanoholes.

The alumina pores in the porous layer (nanohole structure) had a barrier layer at their bottom, and the barrier layer was removed by etching using phosphoric acid to expose the soft magnetic underlayer (CoZrNb) to thereby convert the nanoholes into through holes. This process is the nanohole structure forming process in the method for manufacturing the magnetic recording medium.

Next, a layer of NiFe about 250 nm thick as the soft magnetic layer was formed inside the nanoholes (alumina pores) in the porous layer (nanohole structure) by electrodeposition in a bath housing a solution containing nickel sulfate and iron sulfate using the soft magnetic underlayer (CoZrNb) as the electrode under the application of a negative voltage. The composition of the nickel sulfate and iron sulfate in the solution was a permalloy composition (Ni 80%-Fe 20%). This process is the soft magnetic layer forming process in the method for manufacturing the magnetic recording medium according to the present invention.

Subsequently, a layer of FeCo as the ferromagnetic layer was formed on the soft magnetic layer inside the anodized aluminum pores in the porous layer by electrodeposition using a solution containing FeCo instead of the above solution containing cobalt sulfate and iron sulfate. This process was the ferromagnetic layer forming process in the method for manufacturing the magnetic recording medium.

After polishing a surface of the porous layer, a film of SiO₂ as the protective layer was formed thereon by sputtering. Further, the article was subjected to burnishing and lubricating to thereby yield Sample Disk E as the magnetic recording medium according to the present invention. The ferromagnetic layer in Sample Disk E had a thickness of 250 nm.

As a comparative disk, Sample Disk F was manufactured in the same manner as in Sample Disk E, except that the soft magnetic layer was not formed and that the ferromagnetic layer alone was formed inside the nanoholes in the porous layer (nanohole structure) to a thickness equal to the total thickness of the ferromagnetic layer and soft magnetic layer in Sample Disk E.

As another comparative disk, Sample Disk G was manufactured in the same manner as in Sample Disk E, except that the soft magnetic layer was not formed and that the porous layer (nanohole structure) was polished to a thickness of 250 nm and then the ferromagnetic layer alone was formed inside the nanoholes to a thickness equal to the total thickness of the ferromagnetic layer and soft magnetic layer in Sample Disk E.

Magnetic recording was carried out and recording-reproducing properties were determined on each of the above-manufactured Sample Disks E, F and G. Specifically, using a magnetic recording apparatus having a single pole head as a write magnetic head and a GMR head as readout magnetic head, signals were written on the disk with the single pole head and read out with the GMR head.

The results are shown in FIG. 16. The upper part (a) of FIG. 16 is a graph showing a relationship between the write current at 400 kBPI corresponding to 60 nm pitches and the signal-to-noise ratio S/N of the reproduced signal. The lower part (b) of FIG. 16 below the abscissa was a graph showing the overwrite properties as a function of the write current, in which signals of 200 kBPI with large bits were written, and then signals of 400 kBPI with small bits were overwritten, and the degree of unerased 200-kBPI signals (unerased large bits) was determined.

FIG. 16 shows that Sample Disk E has a more satisfactory S/N ratio and overwrite properties than Comparative Sample Disk F. Sample Disk G showed a defected output envelop in one round of the disk to thereby fail to provide accurate data. This is probably because of irregular thickness of the disk due to a large amount of polishing.

### Example 7

A magnetic recording medium according to the present invention was manufactured in the following manner. Initially, a film of NiFe (Ni 80%-Fe 20%) as the material for the soft magnetic underlayer was formed by sputtering on a silicon substrate serving as the substrate to thereby yield the soft magnetic underlayer 500 nm thick. This was the soft magnetic underlayer forming process in the method for manufacturing the magnetic recording medium.

Next, an aluminum layer was formed on the soft magnetic underlayer by sputtering using aluminum (Al) with a purity of 99.995% as the target to thereby form the metallic layer 500 nm thick. The metallic layer was anodized by the procedure of Example 5, except for using the soft magnetic underlayer (NiFe) as an electrode, to form nanoholes (alumina pores) in the metallic layer (aluminum layer). Thus, a porous layer (nanohole structure) was formed. The nanoholes (alumina pores) had a diameter of opening of 13 nm, an aspect ratio of 38.5 and were spaced concentrically at specific intervals (pitches) to constitute a row of nanoholes.

The anodized aluminum pores in the porous layer (nanohole structure) had a barrier layer at their bottom, and the barrier layer was removed by etching with phosphoric acid to expose the soft magnetic underlayer (NiFe) to thereby convert the nanoholes into through holes. This process is the nanohole structure forming process in the method for manufacturing the magnetic recording medium according to the present invention.

Next, a layer of NiFe about 470 nm thick as the soft magnetic layer was formed inside the nanoholes (alumina pores) in the porous layer (nanohole structure) by electrodeposition in a bath housing a solution containing nickel sulfate and iron sulfate using the soft magnetic underlayer (NiFe) as the electrode under the application of a negative voltage. The composition of the nickel sulfate and iron sulfate in the solution was a permalloy composition (Ni 80%-Fe 20%). This process is the soft magnetic layer forming process in the method for manufacturing the magnetic recording medium.

Next, a layer of Cu as the nonmagnetic layer about 5 nm thick was formed on the soft magnetic layer inside the nanoholes in the porous layer (nanohole structure) by electrodeposition using the soft magnetic underlayer (NiFe) as the electrode under the application of a negative voltage in a bath housing a solution containing copper sulfate. This process is the nonmagnetic layer forming process in the method for manufacturing the magnetic recording medium.

A layer of CoPt as the ferromagnetic layer was formed on the nonmagnetic layer inside the nanoholes in the porous layer (nanohole structure) electrodeposition by the above procedure, except for using a solution containing cobalt sulfate and hexachloroplatinic acid instead of the solution in the bath. This process is the ferromagnetic layer forming process in the method for manufacturing the magnetic recording medium.

After polishing a surface of the porous layer, a film of SiO₂ was formed thereon by sputtering to form the protective layer 3 nm thick. Further, the article was subjected to burnishing and lubricating to thereby yield Sample Disk H as the magnetic recording medium according to the present invention. The ferromagnetic layer in Sample Disk H had a thickness of 20 nm.

As a comparative disk, Sample Disk I was manufactured in the same manner as in Sample Disk H, except that the porous layer and the soft magnetic layer were not formed and that the nonmagnetic layer (Cu) and the ferromagnetic layer (CoPt) were formed on the soft magnetic underlayer (NiFe (Ni 80%-Fe 20%)) to have the same composition and thickness as in Sample Disk H.

Signals were written by magnetic recording on above-manufactured Sample Disks H and I by the procedure of Example 6, except for using a magnetic recording apparatus having a single pole head (magnetic pole size: 20 nm) as a write magnetic head. In this procedure, the single pole head was floated 5 nm over the medium.

The recorded portions in Sample Disks H and I were observed with a magnetic force microscope. As a result, in Sample Disk H, light portions and dark portions of a minimum size of 20 nm corresponding to the orientation of magnetization were observed in the recorded portions, showing that each of the nanoholes (alumina pores) filled with the magnetic material constitutes a single domain. In contrast, in Sample Disk I, no magnetization pattern corresponding to the recording frequency was observed at the same write current (under the same write conditions) as in Sample Disk H, and a recording pattern with a recording bit length of 30 nm or more was observed at a write current 1.5 times or more of that in Sample Disk H. This magnetization pattern had irregular dimensions. These results show that Sample Disk H according to the present invention may enable recording in bits each having a size of 20 nm at a recording density of 1.6 Tb/in².

### Manufacture of Nanohole Structure

As shown in FIG. 17A, initially, a film of aluminum 202 having a thickness of 1,500 nm was formed onto a substrate for hard disk (HDD) magnetic recording media 200 by sputtering. As shown in FIG. 17B, a nanopattern-mold 204 having a line-and-space pattern at a pitch of 60 nm was pressed onto the aluminum film 202 to thereby imprint and transfer the pattern comprising lines (concave portions or grooves) and spaces (convex portions or lands) to the aluminum film 202. The pressure in the imprint transfer was set at 40,000 N/cm² and a linear convex-and-concave pattern comprising rows of concave portions arranged at specific intervals were formed (FIG. 17C). After imprint transfer, as shown in FIG. 17D, anodization was carried out at a voltage of 25 V in a solution of dilute sulfuric acid, and a porous layer (alumite pore) 206 having a thickness of 1,000 nm which comprises a plurality of nanoholes (alumina pores) extending in a direction substantially perpendicular to the substrate 200, was formed. As shown in FIG. 17E, on the surface of the porous layer 206, surplus nanoholes (surplus alumina pores) 207 were scattered and alumina pores 205 were arranged at irregular intervals. This process corresponds to the first porous layer forming process in the method for manufacturing a nanohole structure according to the present invention.

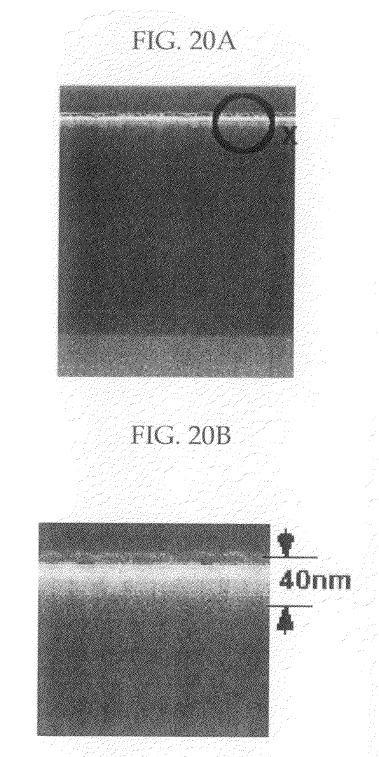

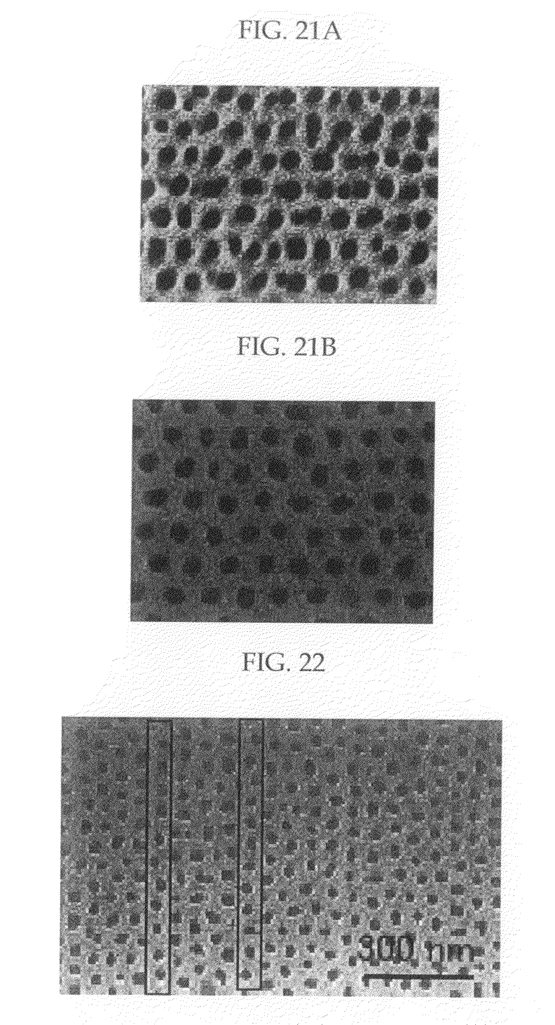

The obtained porous layer 206 was observed by scanning electron microscope (SEM). FIGS. 20A and 20B shows a cross-sectional SEM picture of the porous layer 206 and an enlarged picture of X portion in the vicinity of the surface of the porous layer 206, respectively. From these SEM pictures, from the uppermost surface of the porous layer 206 to the depth less than 40 nm, somewhat irregular intervals between the nanoholes 205 in their array were observed. In contrast, at the depth of 40 nm or more, it was observed that nanoholes 205 were arrayed in rows and found that ideal array was obtained. Further, FIGS. 21A and 21B shows a SEM picture at the uppermost surface of the porous layer 206 and a SEM picture at the depth of 200 nm from the surface, respectively. It was found that from the FIG. 21A, at the uppermost surface of the porous layer, surplus nanoholes (surplus alumina pores) existed, but from the FIG. 21B, at the depth of 200 nm from the uppermost surface of the porous layer, surplus alumina pores did not exist and nanoholes were arrayed regularly.

Next, as shown in FIG. 18A, etching treatment was performed using an etching solution containing chrome and phosphoric acid to thereby selectively remove the porous layer 206 alone. After removal of the porous layer 206, in the aluminum film 202, a trace of the porous layer 208 was formed, and in the trace 208, as shown in FIG. 18B, fine concave portions (alumina pores) 205 were spaced on the rows of concave portions at specific intervals to constitute rows of nanoholes. This process corresponds to the porous layer removing process in the method for manufacturing a nanohole structure according to the present invention.

Using fine concave portions (alumina pores) 205 in the obtained trace of the porous layer, as shown in FIG. 18C, anodization was carried out at a voltage of 25 V in a solution of dilute sulfuric acid and a nanohole structure (porous layer) having a thickness of 100 nm was formed to thereby obtain an arrayed nanohole structure 210 comprising nanoholes 205 being arrayed regularly (FIG. 18D). The average opening diameter of the nanoholes was 30 nm. This process corresponds to the second porous layer forming process in the method for manufacturing a nanohole structure according to the present invention.

The obtained arrayed nanohole structure 210 was observed by SEM. The SEM picture is shown in FIG. 22. FIG. 22 shows that surplus nanoholes were not observed in the arrayed nanohole structure 210 and nanoholes were arrayed regularly and were formed in rows at specific intervals to constitute rows of nanoholes. In the SEM picture shown in FIG. 22, a certain row was selected and for the nanoholes arrayed in the row, coefficient of variation of intervals between adjacent nanoholes was measured by the following method. The results are shown in Table 2.

### Measurement of Coefficient of Variation

For 22 nanoholes which were arrayed in a row shown in FIG. 22, center-to-center distance of adjacent nanoholes was measured, the mean <X> and standard deviation σ thereof were calculated and coefficient of variation was obtained according to the following equation:

CV(%)=σ/<X>×100

wherein CV is the coefficient of variation; σ is standard deviation; and <X> is mean.

TABLE 2

| Nanohole measurement position | Nanohole center-to-center distance (nm) |
|---|---|
| 1-2 | 65.09 |
| 2-3 | 72.09 |
| 3-4 | 58.82 |
| 4-5 | 59.69 |
| 5-6 | 67.46 |
| 6-7 | 60.55 |
| 7-8 | 74.21 |
| 8-9 | 58.82 |
| 9-10 | 70.62 |
| 10-11 | 57.63 |
| 11-12 | 64.69 |
| 12-13 | 57.33 |
| 13-14 | 54.92 |
| 14-15 | 61.74 |
| 15-16 | 58.96 |
| 16-17 | 60.71 |
| 17-18 | 62.02 |
| 18-19 | 60.28 |
| 19-20 | 53.91 |
| 20-21 | 60.28 |
| 21-22 | 69.20 |
| Mean <X> (nm) | 62.33 |
| Standard deviation σ (nm) | 5.58 |
| Coefficient of variation (%) | 8.95 |

From the results of Table 2, it was found that the coefficient of variation of the intervals between adjacent nanoholes was 8.95% and in the arrayed nanohole structure obtained by the method for manufacturing a nanohole structure of the present invention, nanoholes were arrayed regularly without variation.

### Example 9

A magnetic recording medium (magnetic disk) according to the present invention was manufactured in the following manner. Specifically, a layer of FeCoNiB was formed onto a glass substrate as the substrate by electroless plating to form (laminate) a soft magnetic underlayer 500 nm thick. This process is the soft magnetic underlayer forming process in the method for manufacturing the magnetic recording medium according to the present invention.

Next, a film of Nb 5 nm thick and a film of A1 150 nm thick were formed onto the soft magnetic underlayer, respectively, by sputtering. A mold having a line-and-space pattern at a pitch of 60 nm was pressed onto this laminated substrate of aluminum film to thereby imprint and transfer the pattern comprising lines (concave portions or grooves) and spaces (convex portions or lands) to the surface of the aluminum film (FIGS. 17A to 17C).

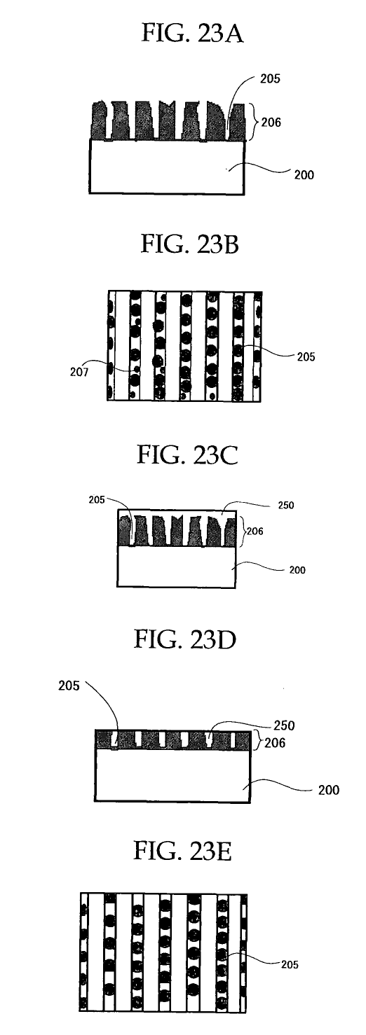

Next, the sample after imprint-transfer was subjected to anodization at a voltage of 25 V in a 0.3 mol/l oxalic acid solution at a bath temperature of 20° C. to thereby form a nanohole structure having a thickness of 200 nm which comprises nanoholes (alumina pores) (FIG. 23A). This process is the nanohole structure forming process in the method for manufacturing the magnetic recording medium.

Surplus nanoholes (surplus alumina pores) 207 were scattered on the surface of the obtained nanohole structure and somewhat irregular intervals between the nanoholes (alumina pores) 205 in their array was observed (FIG. 23B).

Electrodeposition inside the nanoholes was carried out using a plating bath comprising 5 percent by weight copper sulfate solution and 2 percent by weight boric acid solution at a bath temperature of 35° C. to thereby charge cobalt (Co) 250 into the nanoholes 205 to form a ferromagnetic layer inside thereof (FIG. 23C). This process is the magnetic material charging process in the method for manufacturing the magnetic recording medium according to the present invention.

Next, the surface of the nanohole structure which was charged with a magnetic material was polished with CMP. The polishing amount at this time was set to 100 nm of thickness from the uppermost surface (FIG. 23D). After polishing, nanoholes were arrayed regularly on the surface of the nanohole structure, which nanoholes were spaced in rows at specific intervals to constitute rows of nanoholes (FIG. 23E). Further, the surface of the magnetic disk was polished using a lapping tape in order to float the magnetic head. More specifically, the convex portions of alumina to the surface (plane) on which the nanoholes opens was roughly polished using a tape having alumina with a particle size of 3 μm as the lapping tape and was then finish-polished using a tape having alumina with a particle size of 0.3 μm. After the polishing process, the porous layer (alumina layer) had a thickness of about 100 nm and the nanoholes (alumina pores) filled with the cobalt (Co) had an aspect ratio of about 3.

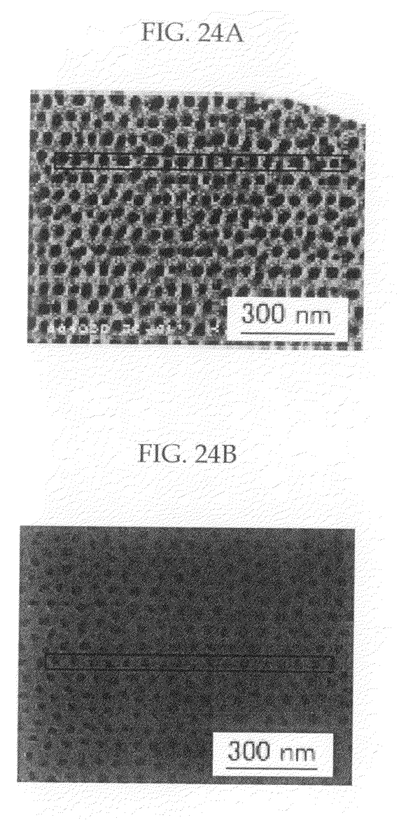

Here, FIGS. 24A and 24B shows SEM pictures of the surface of the nanohole structure before and after the polishing process, respectively. As shown in FIG. 24A, surplus nanoholes (surplus alumina pores) were scattered on the surface of the nanohole structure before the polishing process and some irregular array of the nanoholes was observed. In contrast, as shown in FIG. 24B, nanoholes were arrayed regularly on the surface of the nanohole structure after removal of the thickness of 100 nm in the polishing process.

In the SEM pictures shown in FIGS. 24A and 24B, a certain row was selected and for the nanoholes arrayed in the row, the coefficient of variation of intervals between adjacent nanoholes was measured in the same way as in Example 8. The results are shown in Table 3.

TABLE 3

| | Nanohole center-to-center distance (nm) | |
|---|---|---|
| Nanohole measurement position | Before polishing | After polishing |
| 1-2 | 50.41 | 61.11 |
| 2-3 | 45.13 | 55.43 |
| 3-4 | 43.59 | 55.36 |
| 4-5 | 63.36 | 58.87 |
| 5-6 | 89.08 | 58.91 |
| 6-7 | 46.35 | 54.37 |
| 7-8 | 41.47 | 48.16 |
| 8-9 | 56.61 | 58.80 |
| 9-10 | 42.68 | 61.18 |
| 10-11 | 52.37 | 54.41 |
| 11-12 | 38.92 | 55.98 |
| 12-13 | 45.03 | 60.27 |
| 13-14 | 50.03 | 57.95 |
| 14-15 | 36.76 | 58.97 |
| 15-16 | 60.27 | 52.20 |
| 16-17 | 47.66 | 57.44 |
| 17-18 | 33.78 | 52.20 |
| 18-19 | 45.95 | — |
| 19-20 | 43.39 | — |
| Mean <X> (nm) | 49.10 | 56.57 |
| Standard deviation σ (nm) | 12.25 | 3.55 |
| Coefficient of variation (%) | 24.95 | 6.27 |

From the results shown in Table 3, the coefficient of variation of the intervals between adjacent nanoholes before polishing was 24.95%, while the coefficient of variation after polishing was 6.27%, indicating variation in intervals between adjacent nanoholes before polishing. Thus, it was found that by removing the region where surplus nanoholes in the vicinity of the surface of the nanohole structure exist by the polishing process, nanohole structure comprising nanoholes arrayed regularly without variation can be obtained.

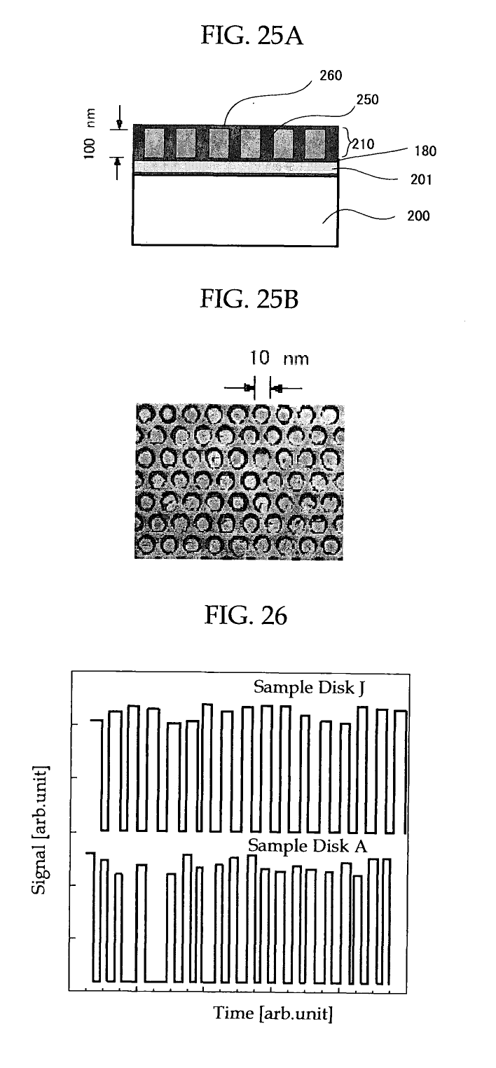

Subsequently, a film of SiO₂ as the protective layer was formed by sputtering, further, perfluoropolyether (AM3001, available from Solvay Solexis) as a lubricant was applied by dipping to thereby form a magnetic disk test sample J shown in FIG. 25A. The magnetic disk sample J comprises a substrate 200, soft magnetic underlayer 201, oxidation stop layer 180, arrayed nanohole structure 210 comprising nanoholes charged with a magnetic material 250, protective layer 260 in this order. The SEM picture of the surface of the arrayed nanohole structure 210 is shown in FIG. 25B. From FIG. 25B, it was found that nanoholes having opening diameter of about 10 nm were arrayed regularly. Further, Sample Disk J was compared with Sample Disk A in Example 1 which was manufactured in the same manner as in Sample Disk J, except that in the polishing process, the thickness of 100 nm from the surface of the nanohole structure was not polished and only polishing using lapping tapes was performed.

Sample Disks J and A were magnetized in a direction perpendicular to the substrate plane using a permanent magnet. Then, magnetic flux intensity was measured along the direction of line using MFM. The variation of the magnetic flux intensity is shown in FIG. 26. The graph in the upper part of FIG. 26 shows intensity variation of the magnetic Sample Disk J and the graph in the lower part shows intensity variation of magnetic Sample Disk A. From FIG. 26, it was found that in the magnetic Sample Disk J, since the intervals between adjacent nanoholes vary small, the signals from the magnetic Sample Disk J had an almost constant pulse interval and intensity. It is considered that Sample Disk J according to the present invention may enable recording of one bit in one dot which does not have variation in pulse interval and avoids crosstalk.

### Example 10

A stamper according to the present invention was manufactured in the following manner. Specifically, the same process as the first porous layer forming process and porous layer removing process in the manufacture of nanohole structure in Example 8, was carried out to thereby obtain a trace of the porous layer 208 where fine concave portions (alumina pores) 205 was arrayed on the rows of concave portions and was spaced at specific intervals to constitute rows of concave portions (rows of alumina pores).

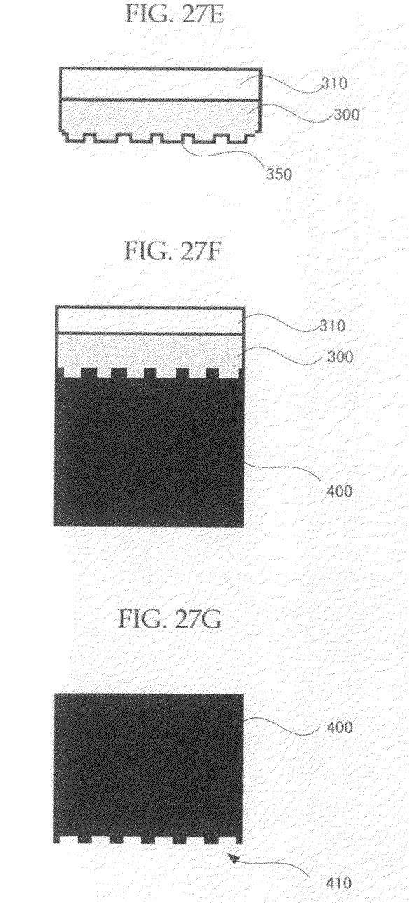

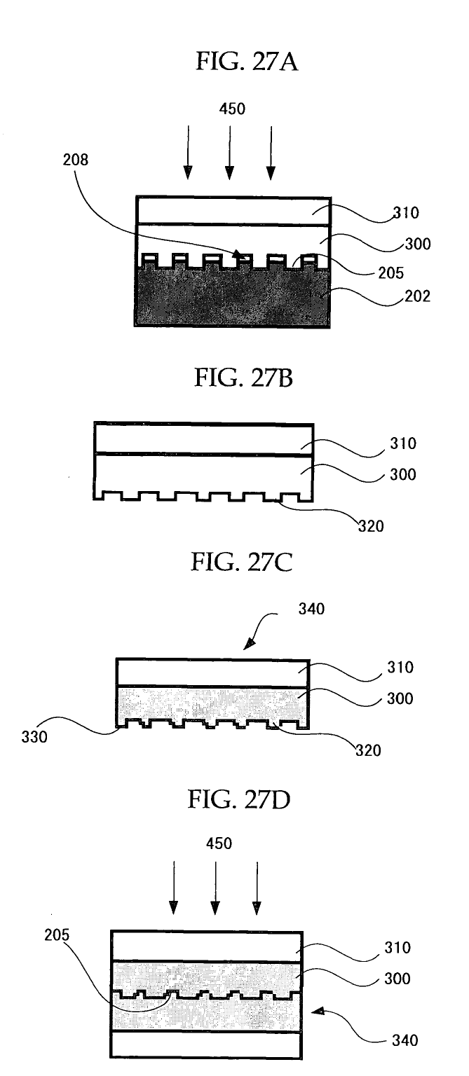

Next, as shown in FIG. 27A, photo-setting polymer was applied on the trace of the porous layer 208 of the aluminum film 202 by spin-coating to thereby form a photo-setting polymer layer 300. A transparent glass plate 310 was placed on the photo-setting polymer layer 300, and the photo-setting polymer layer 300 was exposed to ultraviolet light 450 via the transparent glass plate 310 using a deep UV aligner (wavelength: 257 nm). Then, the aluminum film 202 was peeled off. Thus, as shown in FIG. 27B, the shape of the fine concave portions 205 being arrayed regularly in the trace of the porous layer 208 was transferred to the photo-setting polymer layer 300 and fine convex portions 320 which were capable of engaging with the concave portions 205 and were arrayed regularly, were formed. As shown in FIG. 27C, a film of fluorine mold releasing agent 330 with a thickness of 0.2 nm was applied on the surface of the photo-setting polymer layer 300 comprising convex portions. Here, the photo-setting polymer layer 300 comprising convex portions 320 on which layer the mold releasing agent 330 was coated can be used as the photopolymer stamper 340 of the present invention.

Using the obtained photopolymer stamper 340, as shown in FIG. 27D, shape of convex portions 320 was transferred to the photo-setting polymer layer 300 again and convexity and concavity were reversed to thereby form fine concave portions 205. Next, as shown in FIG. 27E, a film of Cr 350 with a thickness of 20 nm was vapor-deposited on the surface of the photo-setting polymer layer 300 to which surface the trace of the porous layer 208 was transferred (the side where convex portions 320 exist). As shown in FIG. 27F, using the vapor-deposited Cr 350 surface as an electrode, Ni thick plating was carried out in a sulfamic acid bath to thereby form Ni plating 400 with a thickness of 300 μm. The concentration of the sulfamic acid bath was 600 g/I, pH was 4, and current density was 2 A/cm². After the plating, as shown in FIG. 27G, the photo-setting polymer layer 300 was peeled off to thereby obtain the Ni stamper 410 of the present invention comprising circular convex portions which are spaced in rows at specific intervals.

Width and height of the convex portion of the obtained Ni stamper were measured. The width and height of the convex portion was 20 nm and 20 nm, respectively.

Further, the coefficient of variation of the intervals between adjacent nanoholes was measured in the same way as in Example 8 to obtain 6.27%. It was found that intervals between adjacent convex portions did not vary and the convex portions were arrayed regularly.

The present invention solves the problems in conventional technologies and provides a nanohole structure which is useful in magnetic recording media, DNA chips, catalyst carriers and other applications; a method for efficiently manufacturing the nanohole structure at low cost; a stamper which can be suitably used for the manufacture of the nanohole structure and enables efficient manufacture of the nanohole structure; a method for manufacturing the stamper; a magnetic recording medium which is useful in, for example, hard disk devices widely used as external storage for computers and consumer-oriented video recording apparatus, enables recording of information at high density and high speed with a high storage capacity without increasing a write current of a magnetic head, exhibits satisfactory and uniform properties such as overwrite properties, avoids crosstalk and crosswrite and is of very high quality; a method for efficiently manufacturing the magnetic recording medium at low cost; and an apparatus and method for magnetic recording according to the perpendicular recording system using the magnetic recording medium, which enable high-density recording.

The nanohole structure according to the present invention is useful in magnetic recording media such as those used in hard disk devices widely used as external storage for computers and consumer-oriented video recorders, as well as DNA chips, diagnostic devices, detection sensors, catalyst substrates, electron field emission displays and other applications.

The method for manufacturing a nanohole structure of the present invention can be suitably used for the manufacture of the d nanohole structure of the present invention.

The stamper according to the present invention can be suitably used for the manufacture of the nanohole structure and enables efficient manufacture of the nanohole structure of the present invention.

The method for manufacturing a stamper of the present invention can be suitably used for the manufacture of the magnetic recording medium of the present invention.

The magnetic recording media according to the present invention can be suitably used, for example, in hard disk devices widely used typically as external storage for computers and consumer-oriented video recorders.

The method for manufacturing a magnetic recording medium of the present invention can be suitably used for the manufacture of the magnetic recording medium of the present invention.

The magnetic recording apparatus according to the present invention can be suitably used as hard disk devices widely used typically as external storage for computers and consumer-oriented video recorders.

The magnetic recording method according to the present invention enables recording of information at high density and high speed with a high storage capacity without increasing a write current of the magnetic head, exhibits satisfactory and uniform properties such as overwrite properties, avoids crosstalk and crosswrite and is of very high quality.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for manufacturing a nanohole structure, comprising:
forming a porous layer on a metallic matrix so as to have a thickness of 40 nm or more;
removing the porous layer to thereby form a trace of the porous layer; and
forming the porous layer on the trace of the porous layer,
wherein the porous layer comprises nanoholes, the nanoholes each extending in a direction substantially perpendicular to the metallic matrix, and
wherein the trace of the porous layer comprises concave portions being arrayed regularly,
wherein the concave portions are spaced in rows at specific interval to constitute rows of concave portions, and
wherein the nanohole structure comprises:
a metallic matrix; and
nanoholes being arrayed regularly in the metallic matrix,
wherein the nanoholes are spaced in rows at specific intervals to constitute rows of nanoholes.

2. A method for manufacturing a nanohole structure according to claim 1, wherein rows of concave portions are formed on the metallic matrix before forming the porous layer.
